(19) United States
(12) Patent Application Publication
(10) Pub. No.: US 2026/0222712 A1
(43) Pub. Date: Jul. 30, 2026

(54) PHOTODETECTION ELEMENT AND ELECTRONIC DEVICE

(71) Applicant: Sony Semiconductor Solutions Corporation, Kanagawa (JP)

(72) Inventor: Mamoru Sato, Kanagawa (JP)

(21) Appl. No.: 19/146,784

(22) PCT Filed: Feb. 1, 2024
(86) PCT No.: PCT/JP24/03228

§ 371 Date: Jul. 9, 2025

(30) Foreign Application Priority Data
Feb. 27, 2023 (JP) 2023-028240

(51) Int. Cl. H04N 25/778

(52) U.S. Cl. CPC H04N 25/778

(57) ABSTRACT

Photodetection elements and electronic devices with suppressed decrease in signal-to-noise ratio are disclosed. In one example, a photodetection element includes a pixel array with first pixels connected to a first signal line and first amplification transistors that amplify potentials from first photoelectric conversion elements and second pixels connected to a second signal line and including second amplification transistors that amplify potentials from second photoelectric conversion elements. A differential amplification circuit amplifies a potential difference of a differential pair, which is the first amplification transistor of a selected first pixel and the second amplification transistor of a selected second pixel, and a determiner determines, on the basis of the potential difference amplified by the differential amplification circuit, whether or not there is an edge between the selected first pixel and the selected second pixel.

### TECHNICAL FIELD

The present disclosure relates to a photodetection element and an electronic device.

### BACKGROUND ART

In general, edge detection processing is performed to extract features of a subject, such as a shape and size. In addition, in a differential amplification CMOS image sensor (CIS), a technology is known in which a differential amplifier is configured by a readout pixel from which a pixel signal is read out and a reference pixel from which no pixel signal is read out, and a pixel signal differentially amplified by the differential amplifier is read out.

### CITATION LIST

### Patent Document

Patent Document 1: Japanese Patent Application Laid-Open No. 11-225289

### SUMMARY OF THE INVENTION

### Problems to be Solved by the Invention

A signal-to-noise ratio (SNR), however, might deteriorate due to noise superimposition, and there is a possibility that restrictions are imposed on edge extraction under low illuminance. In addition, in order to perform convolution with three or more pixels, it is necessary to provide a plurality of holding units in a column circuit, which results in high cost. Furthermore, a combination of pairs of pixels is fixed by physical wiring, and it is difficult to perform edge detection in flexible patterns. Therefore, the present disclosure provides a photodetection element and an electronic device capable of suppressing a decrease in the SNR.

### Solutions to Problems

In order to solve the above problem, the present disclosure provides a photodetection element including:
a pixel array unit including a plurality of first pixels connected to a first signal line and including first amplification transistors that amplify potentials corresponding to charges obtained as a result of photoelectric conversion performed by first photoelectric conversion elements and a plurality of second pixels connected to a second signal line different from the first signal line and including second amplification transistors that amplify potentials corresponding to charges obtained as a result of photoelectric conversion performed by second photoelectric conversion elements
a differential amplification circuit that amplifies a potential difference of a differential pair, which is the first amplification transistor of a first pixel selected from among the plurality of first pixels and the second amplification transistor of a second pixel selected from among the plurality of second pixels; and
a determiner configured to determine, on the basis of the potential difference amplified by the differential amplification circuit, whether or not there is an edge between the selected first pixel and the selected second pixel.

Each of the plurality of first pixels may include
the first photoelectric conversion element,
a first transfer transistor having one end connected to the first photoelectric conversion element,
a first floating diffusion region connected to another end of the first transfer transistor,
a first reset transistor having one end connected to the first floating diffusion region and another end connected to a power supply of a constant potential,
a first selection transistor having one end connected to the first signal line and another end connected to one end of the first amplification transistor,
and each of the plurality of second pixels may include
the second photoelectric conversion element,
a second transfer transistor having one end connected to the second photoelectric conversion element,
a second floating diffusion region connected to another end of the second transfer transistor,
a second reset transistor having one end connected to the second floating diffusion region and another end connected to the power supply of the constant potential, and
a second selection transistor one end connected to the second signal line and another end connected to one end of the second amplification transistor,
a gate of the first amplification transistor may be connected to the first floating diffusion region, and
a gate of the second amplification transistor may be connected to the second floating diffusion region.

The differential amplification circuit may include
a current mirror current source load connected to a drain of the differential pair via the first signal line and the second signal line, and
a current source connected to another end of the first amplification transistor and another end of the second amplification transistor.

The determiner may output a signal indicating that there is an edge in a case where the potential difference amplified by the differential amplification circuit exceeds a predetermined threshold.

The determiner may output a signal indicating that there is an edge in a case where the potential difference amplified by the differential amplification circuit exceeds a predetermined positive-side threshold.

The determiner may output a signal indicating that there is an edge in a case where the potential difference amplified by the differential amplification circuit exceeds a predetermined negative-side threshold.

The determiner may include a first capacitor having one end connected to the second signal line, and
a converter connected to another end of the first capacitor.

The converter may include
a first transistor that has one end connected to the power supply of the constant potential, that has a first gate connected to the another end of the first capacitor, and that becomes conductive in a case where a predetermined low potential is applied to the first gate, and
a second transistor that has one end connected to another end of the first transistor, that has another end connected to ground, that has a second gate connected to the another end of the first capacitor, and that becomes conductive in a case where a predetermined high potential is applied.

The photodetection element may further include a third transistor that has one end connected to the another end of the first capacitor, that has another end connected to the ground, and that becomes conductive under control of a control unit.

Each of the plurality of first pixels may further include a third capacitor connectable to the first photoelectric conversion element, and
each of the plurality of second pixels may further include a fourth capacitor connectable to the second photoelectric conversion element.

In order to solve the above problem, the present disclosure provides a photodetection element including:
a pixel array unit including a plurality of pixels including first amplification transistors that are connected to a first signal line and amplify potentials corresponding to charges obtained as a result of photoelectric conversion performed by photoelectric conversion elements, and second amplification transistors that are connected to a second signal line different from the first signal line and amplify potentials corresponding to charges obtained as a result of photoelectric conversion performed by the photoelectric conversion elements;
a differential amplification circuit that amplifies a potential difference of a differential pair, which is the first amplification transistor of a first pixel selected from among the plurality of pixels and the second amplification transistor of a second pixel selected from among the plurality of pixels; and
a circuit unit that generates an image signal on the basis of the potential difference amplified by the differential amplification circuit.

Each of the plurality of pixels may include
the photoelectric conversion element,
a first transfer transistor having one end connected to the photoelectric conversion element,
a first floating diffusion region connected to another end of the first transfer transistor,
a first reset transistor having one end connected to the first floating diffusion region and another end connected to a power supply of a constant potential,
a first selection transistor having one end connected to the first signal line and another end connected to one end of the first amplification transistor,
a second transfer transistor having one end connected to the photoelectric conversion element,
a second floating diffusion region connected to another end of the second transfer transistor,
a second reset transistor having one end connected to the second floating diffusion region and another end connected to the power supply of the constant potential, and
a second selection transistor one end connected to the second signal line and another end connected to one end of the second amplification transistor,
a gate of the first amplification transistor may be connected to the first floating diffusion region, and
a gate of the second amplification transistor may be connected to the second floating diffusion region.

The differential amplification circuit may include
a current mirror current source load connected to a drain of the differential pair via the first signal line and the second signal line, and
a current source connected to another end of the first amplification transistor and another end of the second amplification transistor.

The photodetection element may further include a differential amplification circuit that amplifies a potential difference of a differential pair, which is first amplification transistors of a plurality of first pixels selected from the plurality of pixels and second amplification transistors of a plurality of second pixels different from the plurality of first pixels and selected from the plurality of pixels, in which
an image signal may be generated on the basis of the potential difference amplified by the differential amplification circuit.

Each of the plurality of pixels may further include
a first connection transistor having one end connected to the first floating diffusion region and another end connected to a first connection line, and
a second connection transistor having one end connected to the second floating diffusion region and another end connected to a second connection line different from the first connection line.

The first connection transistors of the plurality of selected first pixels may become conductive, and
the second connection transistors of the plurality of selected second pixels may become conductive.

The pixel array unit may further include a third pixel, and
the third pixel may include
a third photoelectric conversion element,
a third transfer transistor having one end connected to the first floating diffusion region of at least one of the plurality of pixels and another end connected to the third photoelectric conversion element, and
a fourth transfer transistor having one end connected to the second floating diffusion region of at least one of the plurality of pixels and another end connected to the third photoelectric conversion element.

The first connection line may be connected to the first connection transistor of a pixel adjacent via a first switching element, and
the second connection line may be connected to the second connection transistor of a pixel adjacent via a third switching element.

In order to solve the above problem, the present disclosure provides a photodetection element including:
a pixel array unit including a plurality of first pixels connected to a first signal line and including first amplification transistors that amplify potentials corresponding to charges obtained as a result of photoelectric conversion performed by first photoelectric conversion elements and a plurality of second pixels connected to a second signal line different from the first signal line and including second amplification transistors that amplify potentials corresponding to charges obtained as a result of photoelectric conversion performed by second photoelectric conversion elements;
a differential amplification circuit that amplifies a potential difference of a differential pair, which is the first amplification transistor of a first pixel selected from among the plurality of first pixels and the second amplification transistor of a second pixel selected from among the plurality of second pixels; and
a circuit unit that generates an image signal on the basis of the potential difference amplified by the differential amplification circuit.

In order to solve the above problem, the present disclosure provides a photodetection element including:
a pixel array unit including a plurality of first pixels connected to a first signal line via first transfer transistors and including first amplification transistors that amplify potentials corresponding to charges obtained as a result of photoelectric conversion performed by first photoelectric conversion elements and second transfer transistors having one ends connected to the first photoelectric conversion elements, and
a plurality of second pixels connected to a second signal line via third transfer transistors and including second amplification transistors that amplify potentials corresponding to charges obtained as a result of photoelectric conversion performed by second photoelectric conversion elements and fourth transfer transistors having one ends connected to the second photoelectric conversion elements,
other ends of the second transfer transistors being connected to the second signal line,
other ends of the fourth transfer transistors being connected to the first signal line; a differential amplification circuit that amplifies a potential difference of a differential pair, which is the first amplification transistor of a first pixel selected from among the plurality of first pixels and the second amplification transistor of a second pixel selected from among the plurality of second pixels; and
a circuit unit that generates an image signal on the basis of the potential difference amplified by the differential amplification circuit.

In order to solve the above problem, the present disclosure provides a photodetection element including:
a pixel array unit including a plurality of first pixels connected to a first signal line directly or via first transfer transistors and including first amplification transistors that amplify potentials corresponding to charges obtained as a result of photoelectric conversion performed by first photoelectric conversion elements and second transfer transistors having one ends connected to the first photoelectric conversion elements,
a plurality of second pixels connected to second photoelectric conversion elements via the first amplification transistors and third transfer transistors,
a plurality of third pixels connected to third photoelectric conversion elements via the first amplification transistors and fourth transfer transistors, and
a plurality of fifth pixels connected to fourth photoelectric conversion elements via the first amplification transistors and fourth transfer transistors.

In order to solve the above-described problem, the present disclosure provides an electronic device including:
a photodetection element, and
an optical system that condenses incident light on the pixel array unit.

Aspects of the present disclosure are not limited to the above-described individual embodiments, but include various modifications that can be conceived by those skilled in the art, and the effects of the present disclosure are not limited to those described above. That is, various additions, modifications, and partial deletions may be made without departing from the conceptual idea and spirit of the present disclosure derived from the matters defined in the claims and equivalents thereof.

### BRIEF DESCRIPTION OF DRAWINGS

FIG. 1 is a block diagram illustrating a configuration example of an electronic device in a first embodiment.

FIG. 2 is a system configuration diagram illustrating a configuration example of an image sensor as a photodetection element.

FIG. 3 is a block diagram illustrating a configuration example of a pixel array unit and a column readout circuit unit.

FIG. 4 is a diagram illustrating an example in which a plurality of first pixels and a plurality of second pixels are alternately arranged, for example, for each row.

FIG. 5 is a circuit diagram illustrating an example of the pixel array unit and a readout circuit.

FIG. 6 is a diagram illustrating an equivalent circuit of the readout circuit in a second mode and a configuration example of a determiner.

FIG. 7 is a diagram illustrating a detailed configuration example of the determiner 3.

FIG. 8 is a time chart illustrating an operation example of a differential amplifier, pixels, and the determiner in the second mode.

FIG. 9 is a diagram illustrating a configuration example of a determiner of a photodetection element according to a second embodiment.

FIG. 10 is a table illustrating an example of output signals of the determiner 3.

FIG. 11 is a time chart illustrating an operation example of the differential amplifier, the pixels, and the determiner.

FIG. 12 is a diagram illustrating a configuration example of a determiner of a photodetection element according to a third embodiment.

FIG. 13 is a time chart illustrating another operation example of the differential amplifier, the pixels, and the determiner.

FIG. 14 is a diagram illustrating another configuration example of the determiner of the photodetection element according to the third embodiment.

FIG. 15 is a time chart illustrating an operation example of the differential amplifier, the pixels, and the determiner.

FIG. 16 is a diagram illustrating a configuration example of a determiner of a photodetection element according to a fifth embodiment.

FIG. 17 is a time chart illustrating another operation example of the differential amplifier, the pixels, and the determiner.

FIG. 18 is a diagram illustrating a configuration example of a first pixel and a second pixel of a photodetection element according to a sixth embodiment.

FIG. 19 is a diagram illustrating a low-gain connection state.

FIG. 20 is a circuit diagram illustrating a configuration example of a pixel according to a seventh embodiment.

FIG. 21 is a diagram illustrating an example of addition and subtraction between two pixels arranged in the same column.

FIG. 22 is a time chart illustrating an operation example of the differential amplifier and the pixels in a third mode.

FIG. 23 is a diagram illustrating an example of addition and subtraction between two pixels arranged in the same row.

FIG. 24 is a time chart illustrating another operation example of the differential amplifier and the pixels in the third mode.

FIG. 25 is a diagram illustrating an operation example of a binning drive example at a high conversion rate.

FIG. 26 is a time chart illustrating another operation example of the differential amplifier and the pixels in the third mode.

FIG. 27 is a diagram illustrating an operation example of a binning drive example at a low conversion rate.

FIG. 28 is a time chart illustrating another operation example of the differential amplifier and the pixels in the third mode.

FIG. 29 is a diagram illustrating a configuration example of two adjacent pixels according to a first modification of the seventh embodiment.

FIG. 30 is a diagram illustrating a configuration example of a pixel according to a second modification of the seventh embodiment.

FIG. 31 is a diagram illustrating a configuration example of pixels according to a third modification of the seventh embodiment.

FIG. 32 is a diagram illustrating a configuration example of pixels according to a fourth modification of the seventh embodiment.

FIG. 33 is a diagram illustrating a configuration example of a photodetection element according to a fifth modification of the seventh embodiment.

FIG. 34 is a diagram illustrating examples of an addition range and addition coefficients of a photodetection element according to a sixth modification of the seventh embodiment.

FIG. 35 is a cross-sectional view of a front-illuminated CMOS image sensor in the present embodiment.

FIG. 36 is a cross-sectional view of a back-illuminated CMOS image sensor.

FIG. 37 is a diagram illustrating an example of a back-illuminated multilayer structure.

FIG. 38 is a diagram illustrating an example of a multilayer structure.

### MODE FOR CARRYING OUT THE INVENTION

Embodiments of an optical element, a processing method, and an electronic device will be described hereinafter with reference to the drawings. Although principal components of the optical element, the processing method, and the electronic device will be mainly described hereinafter, the optical element, the processing method, and the electronic device can have components and functions that are not illustrated or described. The following description is not intended to exclude components and functions that are not illustrated or described.

### First Embodiment

### [Configuration Example of Electronic Device]

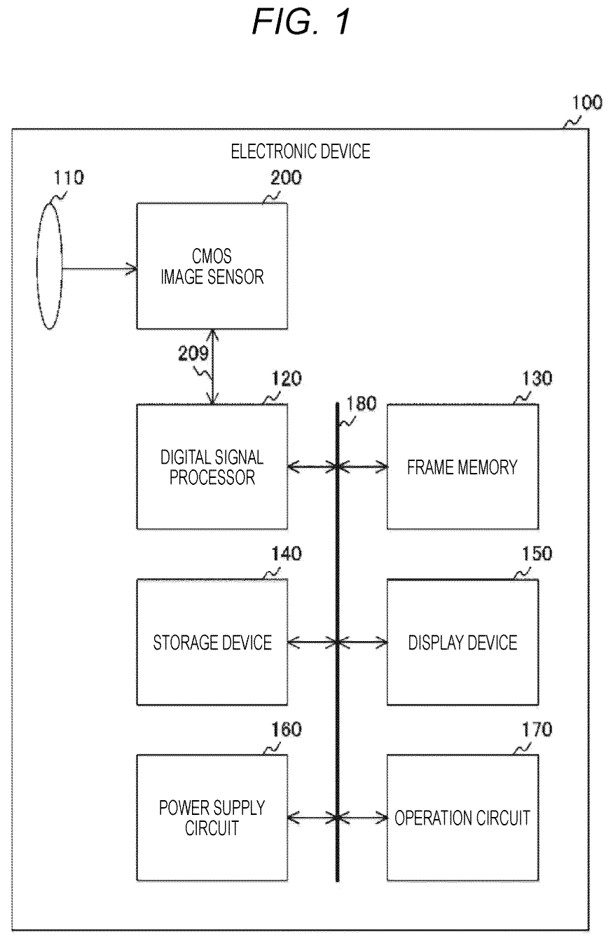

FIG. 1 is a block diagram illustrating a configuration example of an electronic device 100 in a first embodiment. The electronic device 100 is, for example, a device that obtains image data. The electronic device 100 includes an imaging lens 110, an image sensor 200, a digital signal processor 120, a frame memory 130, a storage device 140, a display device 150, a power supply circuit 160, an operation circuit 170, and a bus 180. As the electronic device 100, a digital camera, a mobile device including a camera module, or the like is assumed.

The imaging lens 110 condenses light and guides the light to the image sensor 200. The image sensor 200 performs photoelectric conversion on the light from the imaging lens 110 to generate image data under the control of the digital signal processor 120. The image sensor 200 is, for example, a CMOS image sensor, and supplies the image data to the digital signal processor 120 via a signal line 209.

The digital signal processor 120 performs predetermined image processing on the image data. The digital signal processor 120 controls the image sensor 200 in such a way as to generate image data in response to an operation such as pressing of a shutter button. The digital signal processor 120 then performs various types of image processing on the image data using the frame memory 130 as necessary. For example, as the image processing, processing for generating a contour image based on extracted edges, demosaic processing, white balance processing, synthesis processing, and the like are performed. The digital signal processor 120 supplies the image data subjected to the image processing to the storage device 140 via the bus 180 to store the image data. Furthermore, the digital signal processor 120 displays the image data on the display device 150 in accordance with a user's operation.

The frame memory 130 holds image data (frames). The storage device 140 stores image data. The display device 150 displays image data. The power supply circuit 160 supplies power to circuits in the electronic device 100.

The operation circuit 170 generates an operation signal in accordance with the user's operation and supplies the operation signal to the digital signal processor 120. The bus 180 is a common path for exchanging signals among the digital signal processor 120, the frame memory 130, the storage device 140, the display device 150, the power supply circuit 160, and the operation circuit 170.

### [Configuration Example of Photodetection Element]

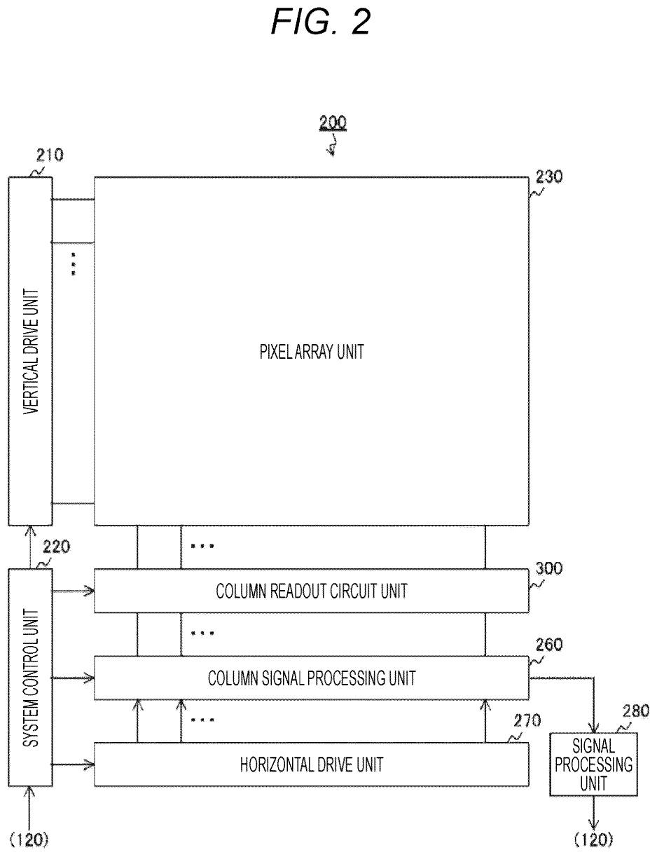

FIG. 2 is a system configuration diagram illustrating a configuration example of the image sensor 200 as a photodetection element to which the present invention is applied. The image sensor 200 (photodetection element) includes a vertical drive unit 210, a system control unit 220, a pixel array unit 230, a column readout circuit unit 300, a column signal processing unit 260, a horizontal drive unit 270, and a signal processing unit 280. The circuits (the vertical drive unit 210 and the system control unit 220) in the image sensor 200 are formed on the same multilayer semiconductor substrate (chip) or a plurality of multilayer semiconductor substrates electrically connected to each other. Note that the column readout circuit unit 300 according to the present embodiment corresponds to a circuit unit.

In the pixel array unit 230, unit pixels each including a photoelectric conversion element capable of performing photoelectric conversion on charge according to the amount of incident light, accumulating a resultant signal therein, and outputting the signal are arranged in two dimensions as a matrix. Note that there is a case where photocharge according to the amount of incident light will be simply referred to as “charge” hereinafter, and the unit pixels will be simply referred to as “pixels”.

In the pixel array unit 230, a pixel drive line is also formed for each of rows of a pixel array in a matrix in a right-and-left direction in the drawing (in an arrangement direction of pixels in pixel rows), and a vertical pixel wire is formed for each of columns in an up-and-down direction in the drawing (in an arrangement direction of pixels in pixel columns). One end of the pixel drive line is connected to an output terminal corresponding to each row of the vertical drive unit.

The column readout circuit unit 300 at least includes a circuit that supplies a constant current to pixels in a selected row in the pixel array unit 230 in units of columns, a current mirror circuit, and a switch for switching readout pixels. Furthermore, the column readout circuit unit 300 constitutes an amplifier together with a transistor in a selected pixel in the pixel array unit 230, converts a photocharge signal into a voltage signal, and outputs the voltage signal to the corresponding vertical pixel wire.

The vertical drive unit 210 is a pixel drive unit that includes a shift register, an address decoder, and the like, and, for example, simultaneously drives all the pixels in the pixel array unit 230 or drives the pixels in units of rows. Although a specific configuration of the vertical drive unit 210 is not illustrated, the vertical drive unit 210 includes a readout scanning system, a sweep scanning system, or batch sweeping and batch transfer.

The readout scanning system sequentially selects and scans the unit pixels of the pixel array unit row by row to read signals from the unit pixels. In the case of row driving (rolling shutter operation), sweep scanning is performed on a readout row on which the readout scanning system performs readout scanning prior to the readout scanning by a time corresponding to a shutter speed. Furthermore, in the case of global exposure (global shutter operation), the batch sweeping is performed prior to the batch transfer by the time corresponding to the shutter speed. As a result of the sweeping operation, unnecessary charge is swept (reset) from the photoelectric conversion elements of the unit pixels in the readout row. A so-called electronic shutter operation is then performed by sweeping (resetting) the unnecessary charge. Here, the electronic shutter operation refers to an operation for sweeping unnecessary photocharge accumulated in the photoelectric conversion elements so far and newly starting exposure (starting accumulation of photocharge). Signals read through the readout operation by the readout scanning system correspond to the amount of incident light after a previous readout operation or electronic shutter operation. In the case of row driving, a period from a readout timing in the previous readout operation or a sweeping timing in the previous electronic shutter operation to a readout time in the current readout operation is an accumulation period for which the unit pixels accumulate photocharge (exposure period). In the case of global exposure, a time from the batch sweeping to the batch transfer is the accumulation period (exposure period).

Pixel signals output from the pixels in the pixel row selectively scanned by the vertical drive unit 210 are supplied to the column signal processing unit 260 via the corresponding vertical pixel wires. The column signal processing unit 260 performs predetermined signal processing on the pixel signal output from each unit pixel in the selected row via the corresponding vertical pixel wire for each pixel column of the pixel array unit, and temporarily holds the pixel signal subjected to the signal processing.

Specifically, the column signal processing unit 260 at least performs, as the signal processing, noise removal processing, that is, for example, correlated double sampling (CDS) processing, in a first mode of normal imaging. As a result of the correlated double sampling by the column signal processing unit 260, fixed pattern noise unique to the pixel, such as reset noise and threshold variation of the amplification transistor, is removed.

In addition, the column signal processing unit 260 executes edge detection processing in a second mode for detecting edges. Note that it is also possible to provide the column signal processing unit with an analowlevelg-to-digital (AD) conversion function, for example, and output a signal level with a digital signal in addition to the noise removal processing.

The horizontal drive unit 270 includes a shift register, an address decoder, and the like, and sequentially selects unit circuits corresponding to a pixel column of the column signal processing unit 260. As a result of the selective scanning by the horizontal drive unit 270, pixel signals subjected to the signal processing by the column signal processing unit 260 are sequentially output to the signal processing unit.

The system control unit 220 includes a timing generator that generates various timing signals and the like. The system control unit 220 controls driving of the vertical drive unit 210, the column signal processing unit 260, the horizontal drive unit 270, and the like on the basis of various timing signals generated by a timing generator.

The image sensor 200 further includes the signal processing unit 280. The signal processing unit 280 at least has an addition processing function, and performs various types of signal processing such as addition processing on the pixel signals output from the column signal processing unit 260. In addition, the signal processing unit 280 executes signal processing for generating a contour image on the basis of coordinates at which edges detected in the second mode exist. Note that the signal processing unit 280 may be an external signal processing unit provided on a substrate different from that of the image sensor 200, that is, for example, a digital signal processor (DSP) or processing achieved by software, or may be mounted on the same substrate as that of the image sensor 200.

### [Configuration Example of Pixel Array Unit and Column Readout Circuit Unit]

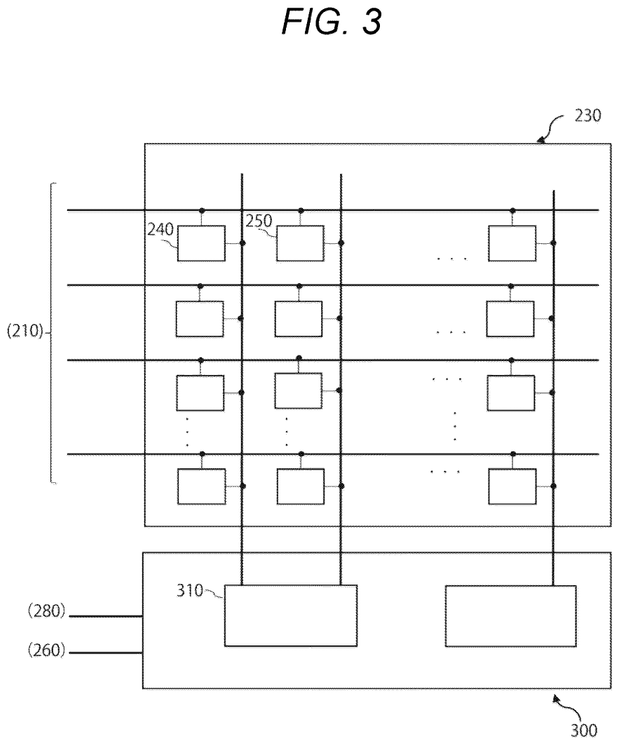

FIG. 3 is a block diagram illustrating a configuration example of the pixel array unit 230 and the column readout circuit unit 300 of the photodetection element 200 according to the first embodiment of the present technology. The pixel array unit 230 according to the present embodiment has three modes. As described above, the first mode is a mode for performing normal imaging in which normal imaging is performed, and the second mode is a mode for performing edge detection. Moreover, a third mode is a mode in which addition and subtraction are performed between a plurality of pixels, which will be described later.

The pixels in the pixel array unit 230 include first pixels 240 and second pixels 250. In the first mode, the first pixels 240 and the second pixels 250 function as pixels for the normal imaging. In the second mode for performing edge detection, on the other hand, each first pixel 240 is a pixel that supplies a reference voltage in a differential amplifier including, for example, the first pixel 240 and the second pixel 250. Note that the pixel array unit 230 according to the present embodiment can also be configured as a pixel array unit 230 having only the second mode. Note that, in the following description, there is a case where the pixel array unit 230 having only the second mode is described, but the pixel array unit 230 having the first mode can also be supported. In addition, there is a case where the pixel array unit 230 having only the third mode is described, but the pixel array unit 230 having the first mode and the second mode can also be supported.

In the pixel array unit 230, for example, a plurality of first pixels 240 and a plurality of second pixels 250 are alternately arranged in a two-dimensional lattice pattern, for example, for each column.

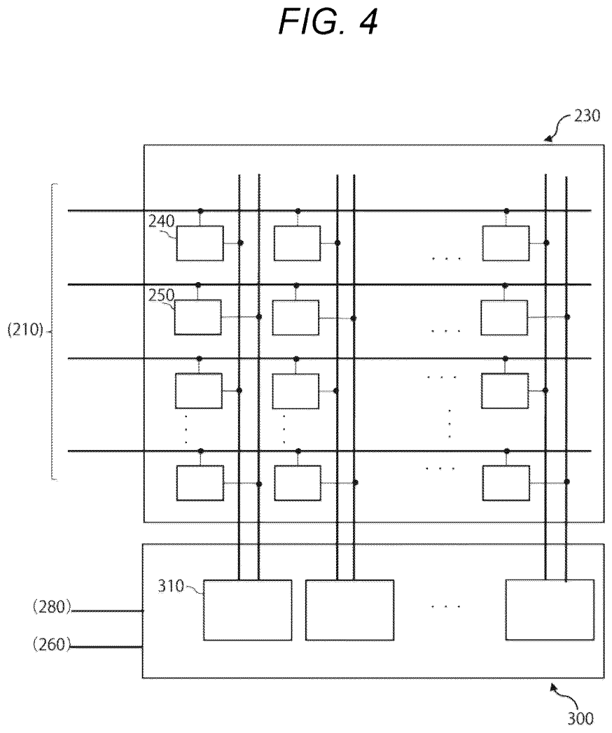

FIG. 4 is a diagram illustrating an example in which a plurality of first pixels 240 and a plurality of second pixels 250 are alternately arranged in a two-dimensional lattice pattern, for example, for each row. By changing the arrangement in this manner, the plurality of first pixels 240 and the plurality of second pixels 250 can be alternately arranged in a two-dimensional lattice pattern, for example, for each row.

In addition, in the column readout circuit unit 300, a readout circuit 310 is provided for each column. The readout circuit 310 supplies pixel signals to the column signal processing unit 260 via a signal line.

Furthermore, in the pixel array unit 230, a pixel drive line is provided for each row, and a vertical pixel wire is provided for each column. Each of reference pixels 240 and signal pixels 250 is connected to the vertical drive unit 210 via a corresponding pixel drive line, and is connected to the readout circuit 310 via a corresponding vertical pixel wire. In addition, in the second mode, a result of the edge detection is output to the signal processing unit 280 (see FIG. 2).

### [Configuration Example of Pixel Circuit]

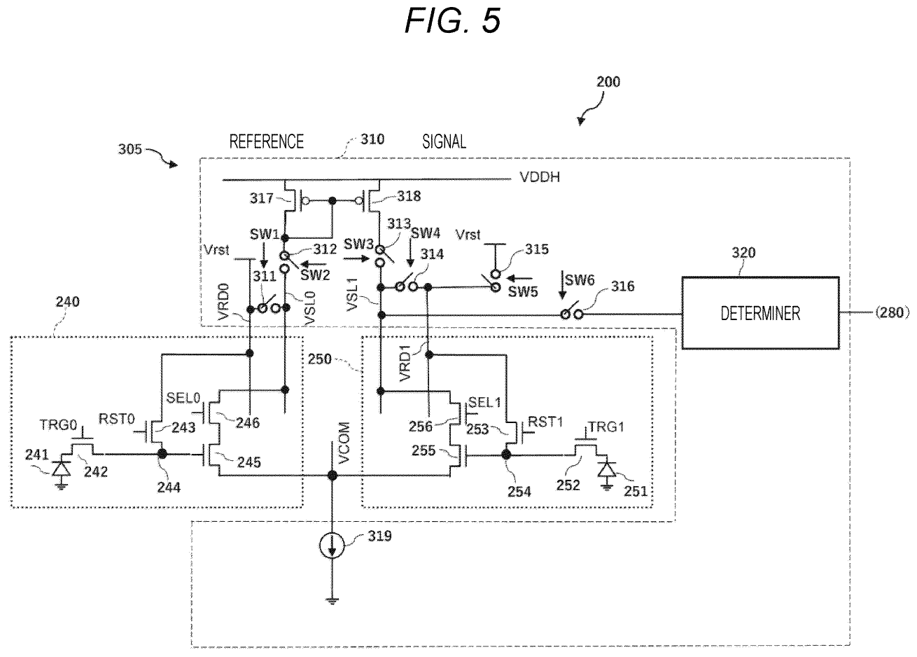

FIG. 5 is a circuit diagram illustrating a configuration example of the pixel array unit 230 and the readout circuit 310 in the first embodiment of the present technology. FIG. 5 is an example of the pixel array unit 230 having the first mode and the second mode.

In the pixel array unit 230, five signal lines including a common signal line VCOM, a reference-side reset bias line VRD0, a reference-side vertical signal line VSL0, a signal-side vertical signal line VSL1, and a signal-side reset bias line VRD1 are provided as vertical pixel wires in a vertical direction. Furthermore, each of the reference-side vertical signal line VSL0 and the signal-side vertical signal line VSL1 is connected to the column signal processing unit 260.

In addition, the first pixel 240 includes a photodiode 241, a transfer transistor 242, a reset transistor 243, a floating diffusion region 244, an amplification transistor 245, and a selection transistor 246.

A drain of the reset transistor 243 is connected to a constant voltage source of a voltage Vrst, and a source is connected to the floating diffusion region 244. The reset transistor 243 turns on/off discharge of charge accumulated in the floating diffusion region 244 in accordance with a drive signal RST0 supplied from the vertical drive unit 210. That is, when a high-level drive signal RSTS is supplied to the reset transistor 243, the floating diffusion region 244 is clamped by the voltage Vrst applied through the reset bias line VRD0, and the charge accumulated in the floating diffusion region 244 is discharged (reset). Furthermore, when a low-level drive signal RST0 is supplied, the floating diffusion region 244 is electrically disconnected from the reset bias line VRD0 and enters a floating state.

The photodiode 241, on the other hand, is a photoelectric conversion element, and performs photoelectric conversion on incident light to generate and accumulate charge according to the amount of light. The transfer transistor 242 turns on/off transfer of charge from the photodiode 241 to the floating diffusion region 244 in accordance with a drive signal TRGS0 supplied from the vertical drive unit 210. For example, the transfer transistor 242 transfers the charge accumulated in the photodiode 241 to the floating diffusion region 244 when the high-level drive signal TRG0 is supplied, and stops the transfer of the charge when the low-level drive signal TRG0 is supplied. Note that while the transfer transistor 242 stops the transfer of the charge to the floating diffusion region 244, the charge generated as a result of the photoelectric conversion is accumulated in the photodiode 241.

The floating diffusion region 244 has a function of accumulating the charge transferred from the photodiode 241 via the transfer transistor 242, and in a floating state in which the reset transistor 243 is turned off, a potential of the floating diffusion region 244 is modulated in accordance with the amount of charge accumulated.

The amplification transistor 245 functions as an amplifier that uses, as input signals, potential fluctuations of the floating diffusion region 244 connected to a gate thereof, and outputs output voltage signals thereof to the vertical signal line VSL0 via the selection transistor 246. A tail current source 319 is connected to sources of the amplification transistors 245 and 255 via a column VCOM line 43. The tail current source 319 can cause a constant current to flow through the amplification transistors 245 and 255.

The selection transistor 246 enables or disables the output of a voltage signal from the amplification transistor 245 to the vertical signal line VSL0 in accordance with a drive signal SEL0 supplied from the vertical drive unit 210. For example, the selection transistor 246 outputs the voltage signal to the vertical signal line VSL0 when the high-level drive signal SEL0 is supplied, and stops outputting the voltage signal when the low-level drive signal SEL0 is supplied. It is therefore possible to extract only an output signal of a selected unit pixel in the vertical signal line VSL0 to which a plurality of unit pixels is connected.

In this manner, the first pixel 240 is driven in accordance with the drive signal TRGS, the drive signal RSTS, and the drive signal SELS supplied from the vertical drive unit 210.

In addition, a level of a pixel signal when the floating diffusion region 244 is initialized will be referred to as a “P-phase level” or a “reset level”. A level of a pixel signal according to the amount of light when charge is transferred from the photodiode 241 to the floating diffusion region 244 will be referred to as a “D-phase level” or a “signal level”.

In addition, the second pixel 250 includes a photodiode 251, a transfer transistor 252, a reset transistor 253, a floating diffusion region 254, an amplification transistor 255, and a selection transistor 256. A connection configuration of these elements is similar to that of the signal pixel 240. A drive signal TRG1, a drive signal RST1, and a drive signal SEL1, however, are supplied from the vertical drive unit 210. Furthermore, a drain of the reset transistor 253 can be connected to a constant voltage source of the voltage Vrst, and a drain of the selection transistor 256 is connected to the vertical signal line VSL1.

### [Configuration Example of Readout Circuit]

In addition, the readout circuit 310 is provided with switches 311 to 316, p-channel metaxide semiconductor (pMOS) transistors 317 and 318, a tail current source 319, and a determiner 320.

A gate of the pMOS transistor 317 is connected to a gate of the pMOS transistor 318. A drain of the pMOS transistor 317 is connected to the gate thereof and the reference-side vertical signal line VSL0 via a switch 312, and a source is connected to a power supply of a power supply voltage VDDH. A drain of the pMOS transistor 318, on the other hand, is connected to the vertical signal line VSL1 via the switch 312, and a source is connected to the power supply voltage VDDH. With this configuration, the pMOS transistor 317 outputs a reference current, and the pMOS transistor 318 outputs a signal current having a value close to the reference current. Such a circuit is called a current mirror circuit. Note that the pMOS transistor 317 and the pMOS transistor 318 according to the present embodiment correspond to current mirror current source loads.

The switch 311 opens and closes a path between the reference-side reset bias line VRD0 and the reference-side vertical signal line VSL0 in accordance with a control signal SW1 from the system control unit 220. The switch 312 opens and closes a path between the pMOS transistor 317 and the reference-side vertical signal line VSL0 in accordance with a control signal SW2 from the system control unit 220.

A switch 313 opens and closes a path between the pMOS transistor 318 and the reference-side vertical signal line VSL1 in accordance with a control signal SW3 from the system control unit 220. A switch 314 opens and closes a path between the signal-side vertical signal line VSL1 and the signal-side reset bias line VRD1 in accordance with a control signal SW4 from the system control unit 220. A switch 315 opens and closes a path between the signal-side reset bias line VRD1 and the constant voltage source of the voltage Vrst in accordance with a control signal SW5 from the system control unit 220. The switch 316 opens and closes a path between the signal-side vertical signal line VSL1 and the determiner 320 in accordance with a control signal SW6 from the system control unit 220.

The tail current source 319 adjusts the current from the common signal line VCOM and a vertical signal line VSL to be constant. The tail current source 319 is achieved by, for example, an n-channel MOS (nMOS) transistor having a gate to which a predetermined bias voltage is applied.

When the first mode is set, the system control unit 220 closes the switches 311, 314, and 315 opens the switches 312, 313, and 316 using the control signals SW1 to SW6.

As described above, in the first mode, the level of the pixel signal when the floating diffusion region 244 is initialized is set as the “P-phase level”, and the pixel signal is read by the column signal processing unit 260 from each pixel. Similarly, a level of the pixel signal according to the amount of light when charge is transferred from the photodiode 241 to the floating diffusion region 244 will be referred to as a “D-phase level”, and the pixel signal is read by the column signal processing unit 260 from each pixel. As a result, image data regarding a captured image is generated through normal AD conversion processing.

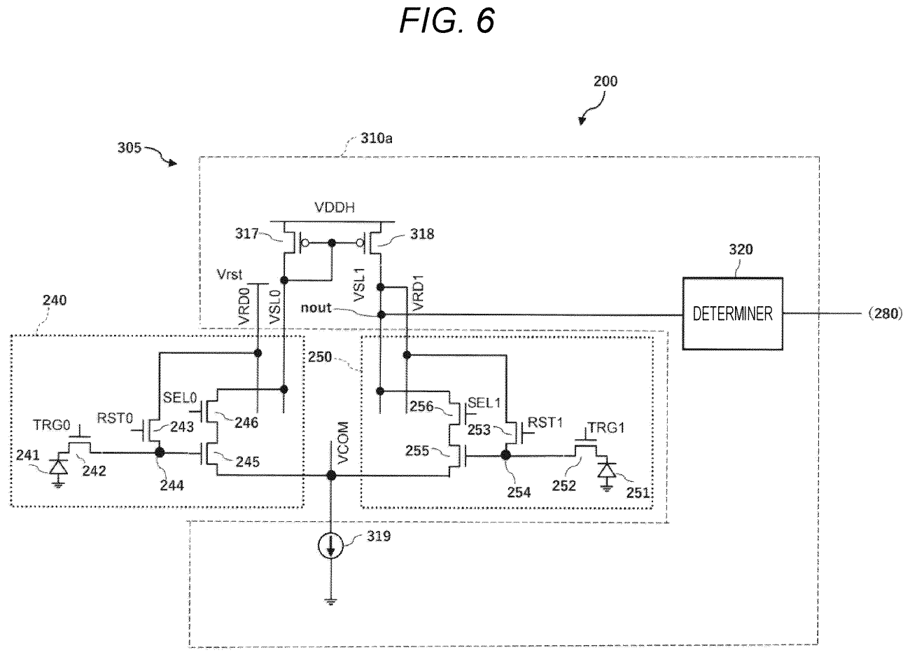

FIG. 6 is a diagram illustrating an equivalent circuit of the readout circuit 310 in the second mode and a configuration example of the determiner 320. A readout circuit 310a is in the same state as the second mode illustrated in FIG. 5. That is, the circuit is equivalent to a case where the switches 312, 313, 314, and 316 are closed and the switches 311 and 315 are opened in FIG. 5.

### [Configuration Example of Differential Amplifier]

As illustrated in FIG. 6, the vertical drive unit 210 selects the first pixel 240 and the second pixel 250 as a differential pair as a plurality of unit pixels from the pixel array unit 230 as a pixel control unit. That is, in the second mode, when the selection transistors 246 and 256 become conductive, the amplification transistors 245 and 255 are selected as a differential pair.

Furthermore, a differential amplifier 305 is configured by the amplification transistors 245 and 255 as the differential pair, the PMOS transistors 317 and 318 constituting the current mirror circuit, and the tail current source 319.

More specifically, the tail current source 319 is connected to one ends of the amplification transistors 245 and 255 via a column VCOM line. An end of the PMOS transistor 317 constituting the current mirror circuit is connected to an end of the selection transistor 246 of the first pixel 240 via the reference-side vertical signal line VSL0. An end of the other PMOS transistor 318 constituting the current mirror circuit is connected to an end of the selection transistor 256 of the second pixel 250 via the reference-side vertical signal line VSL1. Other ends of the PMOS transistors 317 and 318 are connected to the voltage source of the constant voltage VDDH.

The PMOS transistors 317 and 318 constituting the current mirror circuit pass the same current through the reference-side vertical signal line VSL0 on a first pixel 240 side and the signal-side vertical signal line VSL1 on a second pixel 250 side.

As described above, the drain of the reset transistor 243 of the first pixel 240 is connected to the reference-side reset bias line VRD0, and the voltage Vrst is supplied to the reference-side reset bias line VRD0. The drain of the reset transistor 253 of the second pixel 250, on the other hand, is connected to the signal-side reset bias line VRD1, and the signal-side reset bias line VRD1 is connected to the signal-side vertical signal line VSL1.

In the differential differential amplifier 305, the PMOS transistors 317 and 318 constituting the current mirror circuit pass the same current through the reference-side vertical signal line VSL0 on the first pixel 240 side and the signal-side vertical signal line VSL1 on the second pixel 250 side. Furthermore, the differential differential amplifier 305 amplifies, with a predetermined gain, a differential voltage between a gate voltage of the amplification transistor 245 and a gate voltage of the amplification transistor 255, which are input signals of the amplification transistor 245 and the amplification transistor 255, respectively, which are the differential pair, and outputs the differential voltage from an output node nout of the signal-side vertical signal line VSL1. The determiner 320 is connected to the output node nou.

As described above, the vertical drive unit 210 selects the selection transistors 246 and 256 to form a differential pair with the amplification transistors 245 and 255 of the selected first pixel 240 and second pixel 250. The current mirror circuit including the PMOS transistors 317 and 318 is connected to one ends of the amplification transistors 245 and 255, which are the differential pair, as a current mirror current source loads. The tail current source 319 is connected to other ends of the amplification transistors 245 and 255, which are the differential pair. Furthermore, the floating diffusion regions 244 and 254 are connected to gate terminals of the amplification transistors 245 and 255, respectively. Furthermore, the reset transistor 243 resets the floating diffusion region 244 of the first pixel 240 including one side of the differential pair to an arbitrary reset level. In addition, the reset switch 253 for short-circuiting between the floating diffusion region 254 of the second pixel 250 including another side of the differential pair and the output node nou is provided.

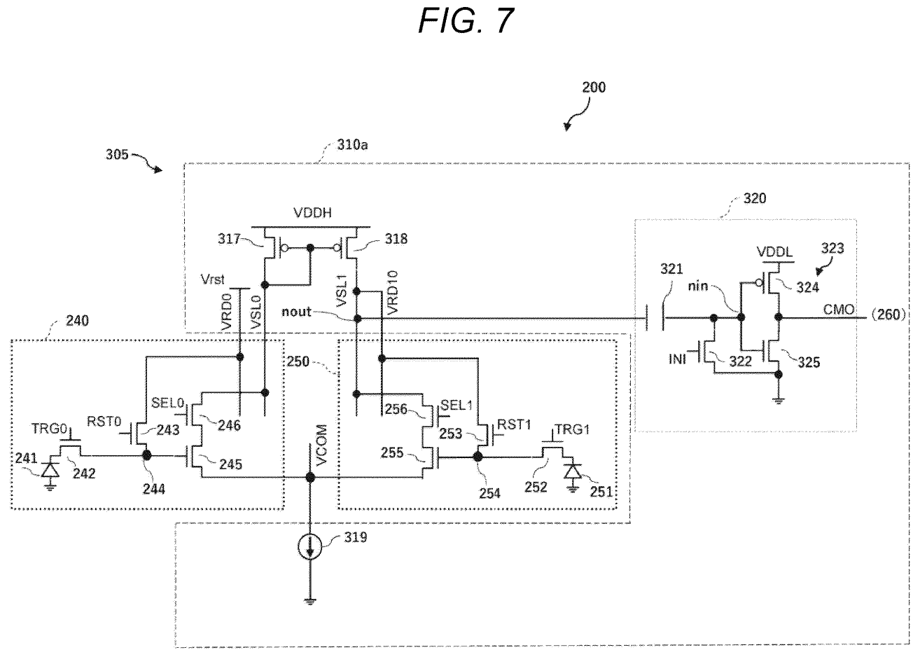

FIG. 7 is a diagram illustrating a detailed configuration example of the determiner 320. As illustrated in FIG. 7, the determiner 320 includes a capacitor 321, a transistor 322, and an inverter 323. The inverter 323 includes a pMOS transistor 324 and an nMOS transistor 325. Gates of the pMOS transistor 324 and the nMOS transistor 325 are connected to each other. A source of the pMOS transistor 324 is connected to a power supply of a low voltage VDDL, and a drain is connected to a source of the nMOS transistor 325. In addition, a drain of the nMOS transistor 325 is connected to the ground. For example, the inverter 323 outputs a high-level signal in a case where a voltage applied to a node nin is lower than a predetermined value, and outputs a low-level signal in a case where the voltage applied to the node nin is equal to or higher than the predetermined value.

Note that the voltage VDDL is, for example, 1 V, and the voltage VDDH is 3 V. In addition, in a case where a film pressure transistor is used for the pMOS transistor 324 and the nMOS transistor 325, the voltage VDDH of 3 V can be used instead of the voltage VDDL.

The capacitor 321 has one end connected to the signal-side vertical signal line VSL1 via the output node nout and another end connected to the gates of the pMOS transistor 324 and the nMOS transistor 325 via the node nin. In addition, one end of the transistor 322 is connected to another end of the capacitor 321 via the node nin, and another end is connected to the ground. In addition, a control signal INI from the system control unit 220 is supplied to a gate of the transistor 322. The transistor 322 becomes conductive in a case where the control signal INI is at a high level, and becomes non-conductive in a case where the control signal INI is at a low level.

In addition, the determiner 320 outputs, for example, a high-level signal to the signal processing unit 280 in a case where the pixel signal exceeds a predetermined positive-side threshold, and outputs a low-level signal to the signal processing unit 280 in a case where the pixel signal does not exceed the threshold. The signal processing unit 280 outputs coordinates of the first pixel 240 and the second pixel 250 at a time when the determiner 320 has detected an edge to the signal processing unit 280 (see FIG. 2). Note that the system control unit 220 can select a combination of the first pixel 240 and the second pixel 250 between any columns by combining the drive signals SEL0 and SEL1. In other words, presence or absence of an edge can be detected at any column interval. Note that, in the case of FIG. 4, presence or absence of an edge can be detected at any row interval.

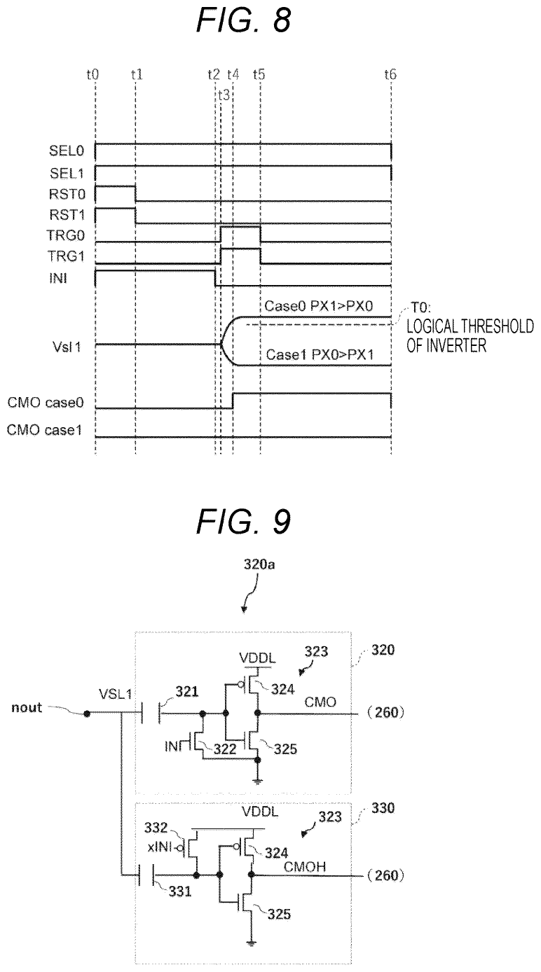

Here, an operation example of the differential amplifier 305, the first pixel 240, and the second pixel 250 according to the present embodiment will be described with reference to FIGS. 7 and 8.

FIG. 8 is a time chart illustrating an operation example of the differential amplifier 305, the pixels 240 and 250, and the determiner 320 in the second mode in which the edge detection processing is performed. Signals SEL0, SEL1, RST0, RST1, TRG0, TRG1, and INI, a potential Vsl1, and signals CMO (case0) and CMO (case1) are illustrated from the top. This potential Vsl1 is a voltage of the signal-side vertical signal line VSL1. The signals CMO (case0) and CMO (case1) are output signals of the determiner 320. In addition, case0 indicates a case where the potential Vsl1 exceeds a logical threshold T0 of the inverter 323, and case1 indicates a case where the potential Vsl1 is equal to or lower than the logical threshold T0 of the inverter 323.

First, imaging for a predetermined time is completed, and at a timing to, the selection control signal SEL0 and the selection control signal SEL1 supplied to the first pixel 240 in the same column as the second pixel 250 for which readout of a pixel signal has been selected are set to a high level (high), and the selection transistor 256 of the second pixel 250 and the selection transistor 246 of the first pixel 240 are turned on. The selection control signal SEL0 and the selection control signal SEL1 are at the high level until a time t6 when the second mode ends, and accordingly the second pixel 250 and the first pixel 240 are selected, and the differential amplifier 305 including the amplification transistors 245 and 255 as a differential pair is configured.

Furthermore, a reset period is started at the timing to, and the reset control signals RST0 and RST1 are set to the high level (high). As a result, the reset transistor 253 of the second pixel 250 and the reset transistor 243 of the first pixel 240 are turned on.

In addition, at the timing to, the control signal IN is set to the high level (high). As a result, a potential of the capacitor 321 of the determiner 320 on an inverter 323 side is initially set to the ground.

In this state, the differential amplifier 305 operates as a voltage follower, a potential of the floating diffusion region 244 of the first pixel 240 becomes the reset voltage Vrst, and potentials of the signal-side vertical signal line VSL1 and the floating diffusion region 254 of the second pixel 250 also follow the reset voltage Vrst. Thereafter, at a next time t1, the set control signals RST0 and RST1 are changed to a low level (LOW), and the reset transistors 253 and 243 are turned off. As a result, the potential of the signal-side vertical signal line VSL1 is initially set. In addition, at a next time t2, the control signal IN is set to the low level (LOW). As a result, the potential of the capacitor 321 of the determiner 320 on the inverter 323 side is allowed to fluctuate.

During a period from a time t3 to a time t5, the high-level transfer control signal TRG0 is supplied to the transfer transistor 242 of the first pixel 240 to turn on the transfer transistor 242 and transfer signal charge accumulated in the PD 241 to the floating diffusion region 244. Similarly, the high-level transfer control signal TRG1 is supplied to the transfer transistor 252 of the second pixel 250 to turn on the transfer transistor 252 and transfer signal charge accumulated in the PD 251 to the floating diffusion region 254.

As a result, a potential difference between the first pixel 240 (PX0) and the second pixel 250 (PX1) is amplified by the differential amplifier 305 and starts to fluctuate as the potential Vsl1 of the signal-side vertical signal line VSL1. In this manner, for example, the potential difference between the potential of the floating diffusion region 244 in the first pixel 240 (PX0) and the potential of the floating diffusion region 254 in the second pixel 250 (PX1) is amplified by the differential amplifier 305 and starts to fluctuate as the potential Vsl1. For example, in a case where the potential of the floating diffusion region 254 in the second pixel 250 (PX1) is higher than the potential of the floating diffusion region 244 in the first pixel 240 (PX0) (Case0), the potential Vsl1 fluctuates to a positive side with respect to the initial setting potential of the floating diffusion region 244 in the first pixel 240 (PX0). In a case where the potential of the floating diffusion region 254 in the second pixel 250 (PX1) is lower than the potential of the floating diffusion region 244 in the first pixel 240 (PX0) (Case1), on the other hand, the potential Vsl1 fluctuates to a negative side with respect to the initial setting potential of the floating diffusion region 244 in the first pixel 240 (PX0).

As a result, for example, if the logical threshold T0 of the inverter 323 is exceeded at time t4 in the case of Case0, the output signal CMO Case0 of the inverter 323 is bit-inverted from the low level to the high level. In other cases, on the other hand, the output signal CMO Case0 and the output signal CMO Case1 of the inverter 323 continue to be at the low level. The edge detection processing in the second mode then ends at a time t6.

In this manner, for example, the potential difference between the potential of the floating diffusion region 244 in the first pixel 240 (PX0) and the potential of the floating diffusion region 254 in the second pixel 250 (PX1) is amplified by the differential amplifier 305 and input to the inverter 323. As a result, when the potential difference between the potential of the floating diffusion region 244 and the potential of the floating diffusion region 254 exceeds a predetermined value, it can be determined that an edge is present. In this case, since the potential difference between the potential of the floating diffusion region 244 and the potential of the floating diffusion region 254 is amplified, an effect on noise is suppressed.

As described above, according to the present embodiment, the vertical drive unit 210 selects the selection transistors 246 and 256 to form the differential pair 245 and 255 with the amplification transistors 245 and 255 of the selected first pixel 240 and second pixel 250. The differential amplifier 305 including the differential pairs 245 and 255 amplifies the potential difference between the potential of the floating diffusion region 244 and the potential of the floating diffusion region 254 in the second pixel 250 (PX1), and inputs the potential difference to the determiner. As a result, in a case where the potential difference between the potential of the floating diffusion region 244 and the potential of the floating diffusion region 254 exceeds the predetermined value, it can be determined that an edge is present.

### Second Embodiment

A photodetection element 200 according to a second embodiment is different from the photodetection element 200 according to the first embodiment in further including a determiner 330 that detects a potential difference between the potential of the floating diffusion region 244 in the first pixel 240 (PX0) amplified to a negative side and the potential of the floating diffusion region 254 in the second pixel 250 (PX1). Differences from the photodetection element 200 according to the first embodiment will be described hereinafter.

FIG. 9 is a diagram illustrating a configuration example of a determiner 320a of the photodetection element 200 according to the second embodiment. As illustrated in FIG. 9, the determiner 320a according to the second embodiment includes a determiner 320 and a determiner 330. That is, the determiner 330 is further connected to the output node nout and configured.

The determiner 330 includes a capacitor 331, a pMOS transistor 332, and an inverter 323.

The capacitor 331 has one end connected to the output node nout of the signal-side vertical signal line VSL1 and another end connected to gates of the pMOS transistor 324 and the nMOS transistor 325. In addition, a source of the pMOS transistor 332 is connected to the constant voltage source of the voltage VDDL, and a drain is connected to an input terminal of the inverter 323. Furthermore, a control signal xINI from the system control unit 220 is supplied to a gate of the pMOS transistor 332. The pMOS transistor 332 becomes conductive in a case where the control signal xINI is at the low level, and becomes non-conductive when the control signal xINI is at the high level.

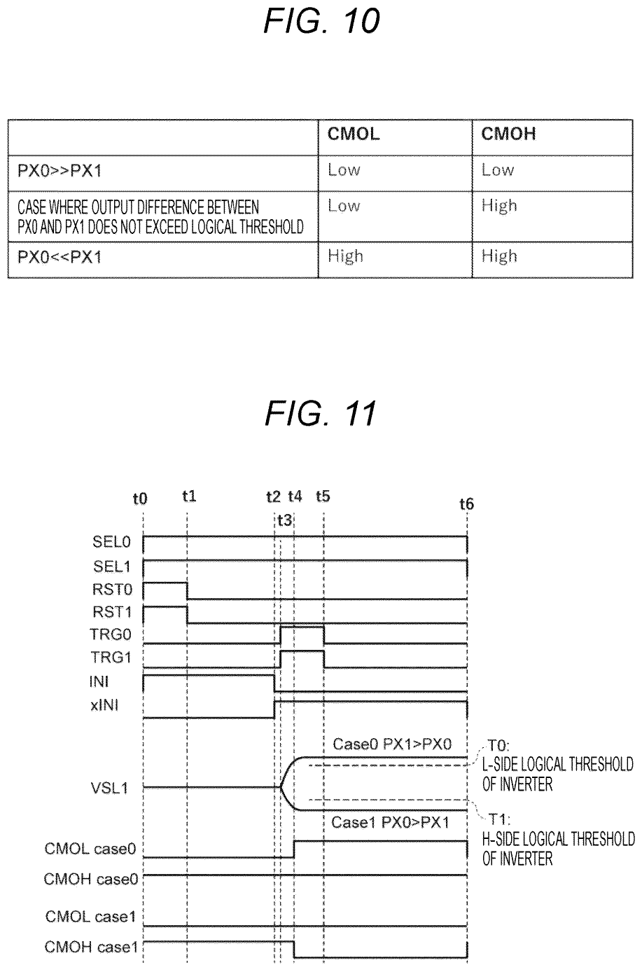

FIG. 10 is a table illustrating an example of output signals of the determiners 320 and 330. As illustrated in FIG. 10, the output signal of the determiner 320 is a signal CMOL, and the output signal of the determiner 330 is a signal CMOH.

That is, in a case where the potential difference between the first pixel 240 (PX0) and the second pixel 250 (PX1) exceeds a predetermined positive-side threshold T0, the determiner 320 outputs a high-level signal to the signal processing unit 280. That is, in a case where the potential on the second pixel 250 (PX1) side exceeds the potential of the first pixel 240 (PX0), the high-level signal is output to the signal processing unit 280. In a case where the predetermined positive-side threshold T0 is not exceeded, on the other hand, a low-level signal is output.

In a case where the potential difference between the first pixel 240 (PX0) and the second pixel 250 (PX1) exceeds a predetermined negative-side threshold T1, the determiner 330 outputs a low-level signal to the signal processing unit 280. That is, in a case where the potential on the first pixel 240 (PX0) side exceeds the potential of the second pixel 250 (PX1), the low-level signal is output to the signal processing unit 280. In a case where the predetermined negative-side threshold T1 is not exceeded, on the other hand, a high-level signal is output.

As can be seen from the above, a case where both the signal CMOL and the signal CMOH are at the high level indicates a case where the potential on the first pixel 240 (PX0) side exceeds the potential of the second pixel 250 (PX1) and the potential difference exceeds the predetermined threshold T1.

In addition, a case where both the signal CMOL and the signal CMOH are at the low level indicates a case where the potential on the second pixel 250 (PX1) side exceeds the potential of the first pixel 240 (PX0) and the potential difference exceeds the predetermined threshold T0. A case where values of the signal CMOL and the signal CMOH are different from each other, on the other hand, indicates a case where the potential difference between the first pixel 240 (PX0) and the second pixel 250 (PX1) does not exceed the thresholds T0 and T1. By setting the thresholds T0 and T1 in this manner, it is possible to select an edge corresponding to a target potential difference.

FIG. 11 is a time chart illustrating an operation example of the differential amplifier 305, the pixels 240 and 250, and the determiners 320 and 330 that perform the edge detection processing. The signals SEL0, SEL1, RST0, RST1, TRG0, TRG1, and INI, the potential Vsl1, and the signals CMO (case0) and CMO (case1) are illustrated from the top. This potential Vsl1 is the voltage of the signal-side vertical signal line VSL1. Signals CMOL (case0), CMOH (case0), CMOL (case1), and CMOH (case1) are output signals of the determiners 320 and 330. In addition, case0 indicates a case where the potential Vsl1 is equal to or higher than the logical threshold T0 of the inverter 323, and case1 indicates a case where the potential Vsl1 is equal to or lower than the logical threshold T0 of the inverter 323.

First, imaging for a predetermined time is completed, and at a timing to, the selection control signal SEL0 and the selection control signal SEL1 supplied to the first pixel 240 in the same column as the second pixel 250 for which readout of a pixel signal has been selected are set to a high level (high), and the selection transistor 256 of the second pixel 250 and the selection transistor 246 of the first pixel 240 are turned on. The selection control signal SEL0 and the selection control signal SEL1 are at the high level until a time t6 when the second mode ends, and accordingly the second pixel 250 and the first pixel 240 are selected.

Furthermore, a reset period is started at the timing to, and the reset control signals RST0 and RST1 are set to the high level (high). As a result, the reset transistor 253 of the second pixel 250 and the reset transistor 243 of the first pixel 240 are turned on.

In addition, at the timing to, the control signal IN is set to the high level (high), and the control signal xINI is set to the low level (high). As a result, the potential of the capacitor 321 of the determiner 320 on an inverter 323 side is initially set to the ground. The potential of the capacitor 331 of the determiner 330 on the inverter 323 side is initially set to the potential VDDL.

In this state, the differential amplifier 305 operates as a voltage follower, the potential of the floating diffusion region 244 of the first pixel 240 becomes the reset voltage Vrst, and the potentials of the signal-side vertical signal line VSL1 and the floating diffusion region 254 of the second pixel 250 also follow the reset voltage Vrst. Thereafter, at a next time t1, the set control signals RST0 and RST1 are changed to the low level (LOW), and the reset transistors 253 and 243 are turned off. As a result, the potential of the signal-side vertical signal line VSL1 is initially set. In addition, at a next time t2, the control signal IN is set to the low level (LOW). As a result, the potential of the capacitor 321 of the determiner 320 on the inverter 323 side is allowed to fluctuate.

During a period from a time t3 to a time t5, the high-level transfer control signal TRG0 is supplied to the transfer transistor 242 of the first pixel 240 to turn on the transfer transistor 242 and transfer signal charge accumulated in the PD 241 to the floating diffusion region 244. Similarly, the high-level transfer control signal TRG1 is supplied to the transfer transistor 252 of the second pixel 250 to turn on the transfer transistor 252 and transfer signal charge accumulated in the PD 251 to the floating diffusion region 254.

As a result, the potential difference between the first pixel 240 (PX0) and the second pixel 250 (PX1) is amplified by the differential amplifier 305 and starts to fluctuate as the potential Vsl1 of the signal-side vertical signal line VSL1. As a result, as illustrated in FIG. 10, the signal values of the signal CMOL and the signal CMOH are divided into cases.

As described above, according to the present embodiment, the determiner 330 is configured to output the low-level signal to the signal processing unit 280 in a case where the potential difference between the first pixel 240 (PX0) and the second pixel 250 (PX1) exceeds the predetermined negative-side threshold T1, and output the high-level signal in a case where the potential difference does not exceed the predetermined negative-side threshold T1. As a result, a state of an edge can be determined on the basis of the combination of the signal CMOL and the signal CMOH. By setting the thresholds T0 and T1 in this manner, it is possible to select an edge corresponding to a target potential difference.

### Third Embodiment

A photodetection element 200 according to a third embodiment is different from the photodetection element 200 according to the first embodiment in that the determiner 320 further includes a positive feedback circuit. Differences from the photodetection element 200 according to the first embodiment will be described hereinafter.

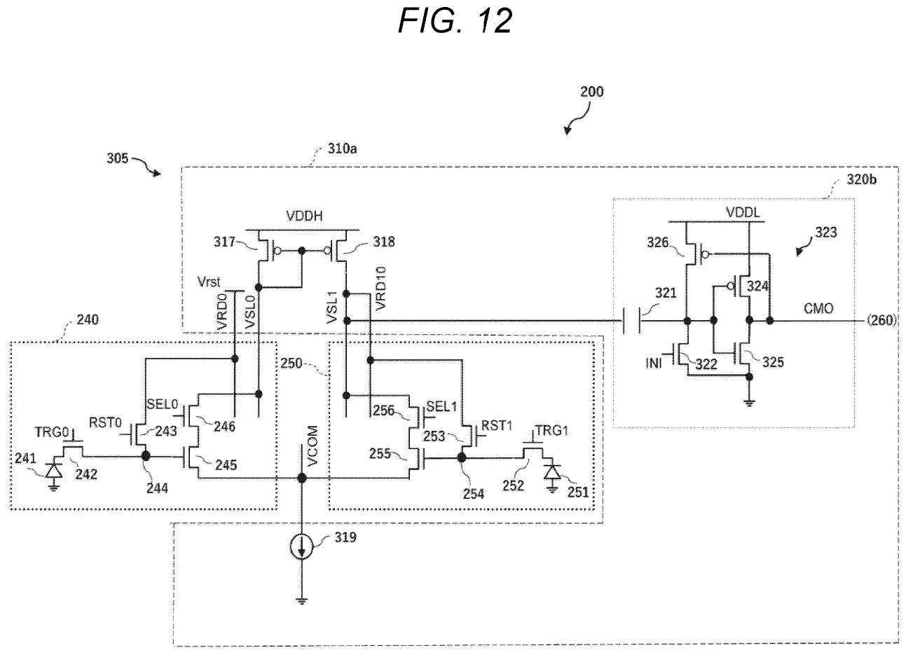

FIG. 12 is a diagram illustrating a configuration example of a determiner 320b of the photodetection element 200 according to the third embodiment. As illustrated in FIG. 12, the determiner 320b further includes a pMOS transistor 326 as a positive feedback circuit. A source of the pMOS transistor 326 is connected to the constant voltage source of the voltage VDDL, and a drain is connected to the input terminal of the inverter 323. In addition, the gate terminal is connected to the output terminal of the inverter 323.

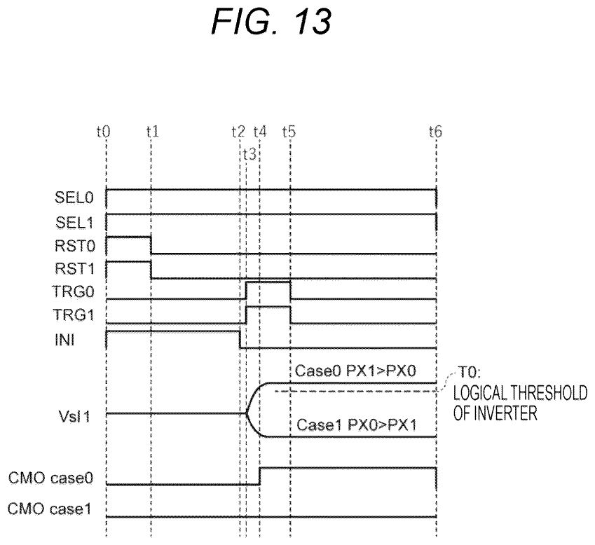

FIG. 13 is a time chart illustrating an operation example of the differential amplifier 305, the pixels 240 and 250, and the determiner 320a that perform the edge detection processing. That is, similarly to FIG. 8, the signals SEL0, SEL1, RST0, RST1, TRG0, TRG1, and INI, the potential Vsl1, and the signals CMO (case0) and CMO (case1) are illustrated from the top. In this case, in a case where the potential of the first image 4240 (PX0) is higher than the potential of the second pixel 250 (PX1), convergence is achieved faster than in the example illustrated in FIG. 8.

### Fourth Embodiment

A photodetection element 200 according to a fourth embodiment is different from the photodetection element 200 according to the first embodiment in that a determiner 320c further includes a circuit that controls a comparison timing. Differences from the photodetection element 200 according to the first embodiment will be described hereinafter.

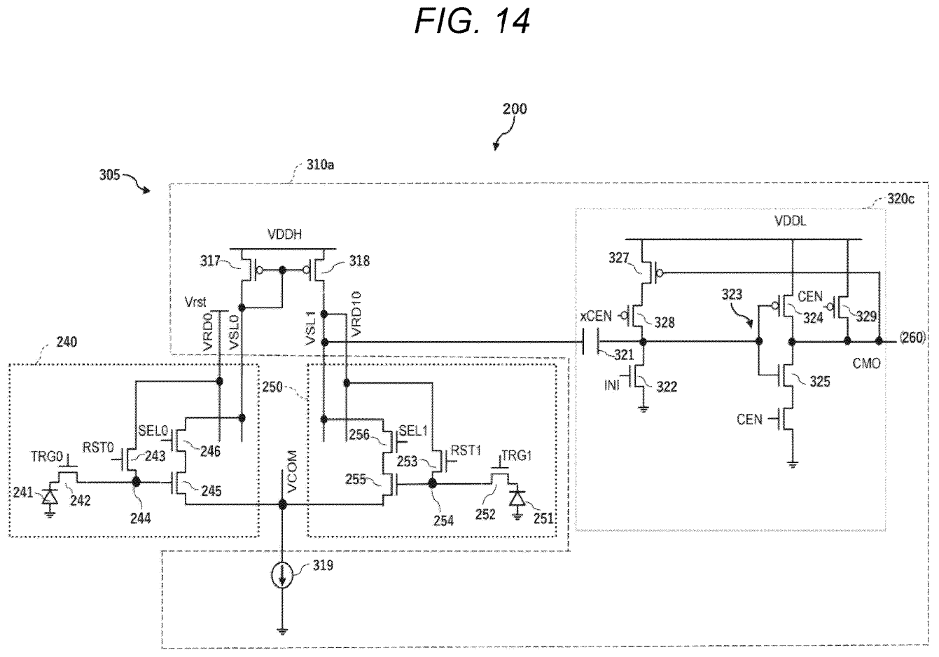

FIG. 14 is a diagram illustrating a configuration example of a determiner 320c of the photodetection element 200 according to the third embodiment. As illustrated in FIG. 14, the determiner 320c further includes pMOS transistors 327, 328, and 329 as circuits for controlling the comparison timing. The pMOS transistors 327 and 328 are connected in series, a source of the pMOS transistor 327 is connected to a constant voltage source of the voltage VDDL, and a drain of the pMOS transistor 328 is connected to an input terminal of the inverter 323. A gate terminal of the pMOS transistor 327 is connected to an output terminal of the inverter 323, and a control signal xCEN is supplied to a gate terminal of the pMOS transistor 328 from the system control unit 120 (see FIG. 2). The control signal xCEN is an inverted signal of a control signal CEN.

In addition, a source of the pMOS transistor 329 is connected to the constant voltage source of the voltage VDDL, and a drain is connected to an output terminal of the inverter 323. Furthermore, the control signal CEN is supplied from the system control unit 120 (see FIG. 2) to a gate terminal of the pMOS transistor 329.

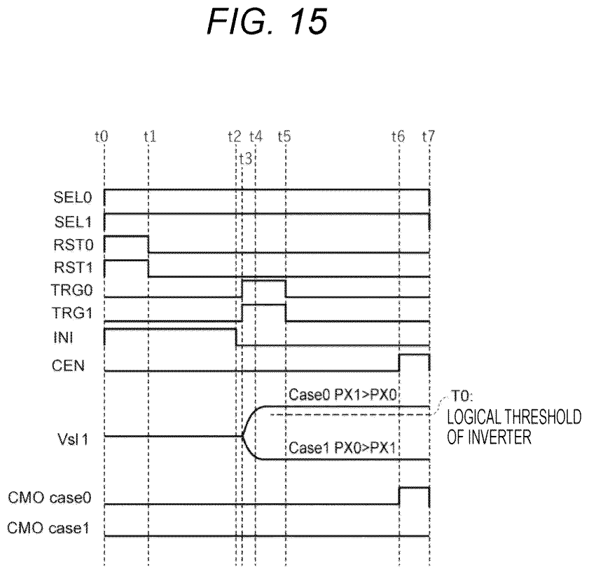

FIG. 15 is a time chart illustrating an operation example of the differential amplifier 305, the pixels 240 and 250, and the determiner 320b that perform the edge detection processing. That is, similarly to FIG. 8, the signals SEL0, SEL1, RST0, RST1, TRG0, TRG1, INI, and CEN, the potential Vsl1, and the signals CMO (case0) and CMO (case1) are illustrated from the top. In FIG. 15, the control signal xCEN is omitted. Although control processing similar to that in FIG. 8 is performed until a timing t6, the control signal CEN is maintained at the low level, and the control signal xCEN is maintained at the high level. As a result, until the timing t6, the pMOS transistor 329 is conductive, and the voltage of the output terminal is maintained at the voltage VDDL. The pMOS transistor 328, on the other hand, continues to be non-conductive.

Next, in a period from the timing t6 to a timing t7, the control signal CEN is maintained at the high level, and the control signal xCEN is maintained at the low level. As a result, the pMOS transistor 329 continues to be non-conductive in the period from the timing t6 to the timing t7. The pMOS transistor 328, on the other hand, continues to be conductive. A conductive state of the pMOS transistor 327 varies in accordance with the output value of the inverter 323. That is, in a case where the output value of the inverter 323 is at the high level, the pMOS transistor 327 continues to be non-conductive, and the determiner 320b outputs the high-level signal. In a case where the output value of the inverter 323 is at the low level, on the other hand, the pMOS transistor 327 continues to be conductive, and the determiner 320b outputs the low-level signal. In this manner, the determiner 320b further includes a circuit that controls the comparison timing, and the determination timing of the determiner 320b can be controlled.

### Fifth Embodiment

A photodetection element 200 according to a fifth embodiment is different from the photodetection element 200 according to the first embodiment in that a determiner 320d can set the initial potential of the capacitor 321 on the inverter 323 side to an arbitrary potential. Differences from the photodetection element 200 according to the first embodiment will be described hereinafter.

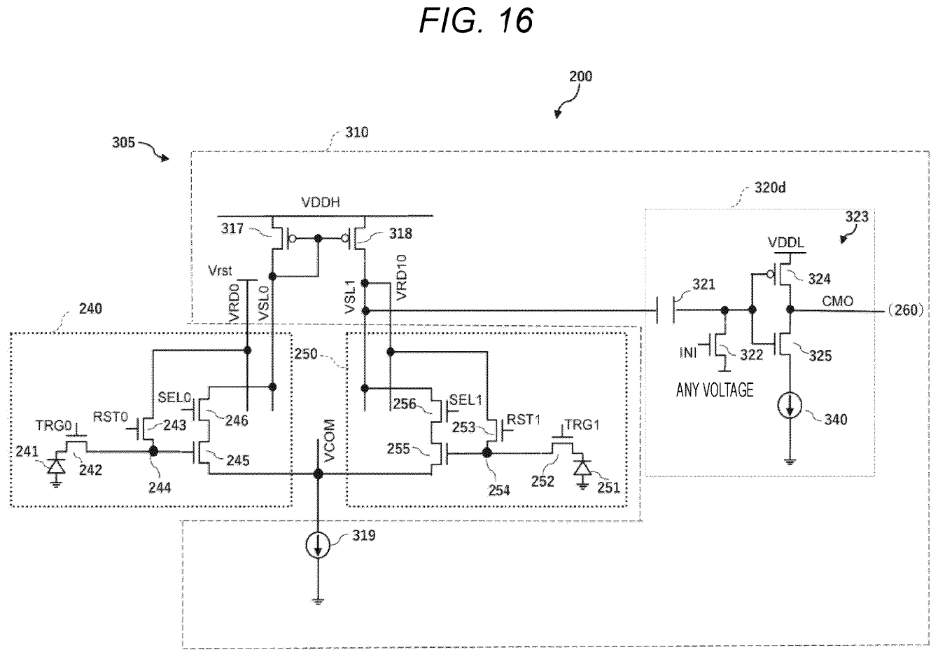

FIG. 16 is a diagram illustrating a configuration example of the determiner 320d of the photodetection element 200 according to the fifth embodiment. As illustrated in FIG. 16, the determiner 320c further includes a current source 340. In addition, a drain of the nMOS transistor 325 on a ground side is connected to the ground via the current source 340.

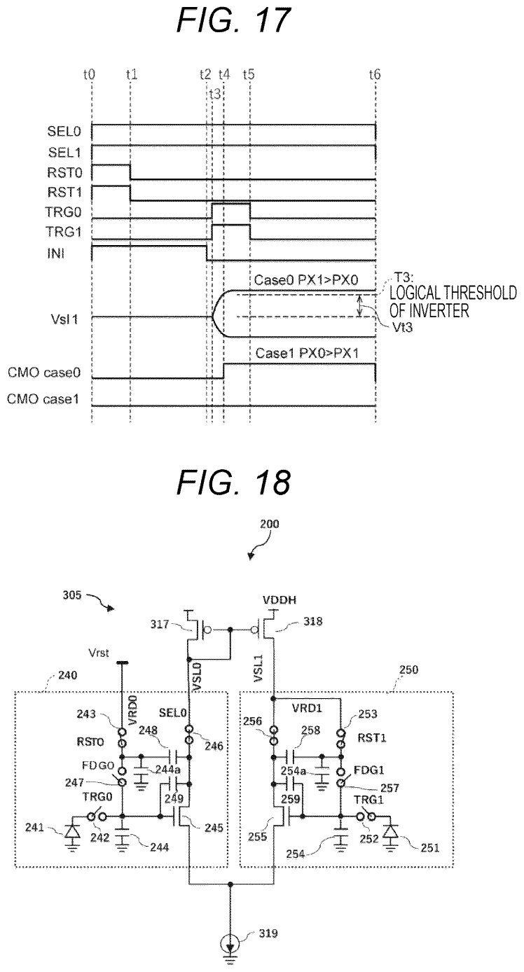

FIG. 17 is a time chart illustrating an operation example of the differential amplifier 305, the pixels 240 and 250, and the determiner 320c that perform the edge detection processing. That is, similarly to FIG. 8, the signals SEL0, SEL1, RST0, RST1, TRG0, TRG1, and INI, the potential Vsl1, and the signals CMO (case0) and CMO (case1) are illustrated from the top. As illustrated in FIG. 17, the initial potential of the capacitor 321 on the inverter 323 side is set to an arbitrary potential between the timing to and the timing t1 when the INI is at the high level. As a result, a logic threshold T3 of the inverter 323 can be set within a potential width of a potential Vt3.

### Sixth Embodiment

A photodetection element 200 according to a sixth embodiment is different from the photodetection element 200 according to the first embodiment in that capacitance of the first pixel 240 and the second pixel 250 can be switched. Differences from the photodetection element 200 according to the first embodiment will be described hereinafter.

FIG. 18 is a diagram illustrating a configuration example of a first pixel 240 and a second pixel 250 of the photodetection element 200 according to the sixth embodiment. FIG. 18 is a diagram illustrating a high-gain connection state. As illustrated in FIG. 18, the first pixel 240 further includes capacitors 244a, 248, and 249 and switching elements 243, 246, and 247. Capacitances of the floating diffusion region 244 and the capacitors 244a, 248, and 249 are CFD1, CFD2, CFD1-VSL2, and CFD1-VSL1, respectively. Similarly, the second pixel 250 further includes capacitors 254a, 258, and 259 and switching elements 253, 256, and 257. Capacitances of the floating diffusion region 254 and the capacitors 254a, 258, and 259 are CFD1, CFD2, CFD1-VSL2, and CFD1-VSL1, respectively.

The switching elements 243 and 247 are connected in series, one end of the switching element 243 is connected to the constant voltage source of the voltage Vrst, and one end of the switching element 247 is connected to the floating diffusion region 244. In addition, one end of the capacitor 244a is connected to another end of the switching element 243, and another end of the capacitor 244a is connected to the ground. In addition, in addition, one end of the capacitor 248 is connected to another end of the switching element 243, and another end of the capacitor 248 is connected to the signal-side vertical signal line VSL1. The switching element 246 can make the signal-side vertical signal line VSL1 conductive or non-conductive. One end of the capacitor 249 is connected to the floating diffusion region 244, and another end is connected to the signal-side vertical signal line VSL1.

Similarly, the switching elements 253 and 257 are connected in series, one end of the switching element 253 is connected to the reference-side vertical signal source, and one end of the switching element 257 is connected to the floating diffusion region 254. In addition, one end of the capacitor 254a is connected to another end of the switching element 253, and another end of the capacitor 254a is connected to the ground. In addition, in addition, one end of the capacitor 258 is connected to another end of the switching element 253, and another end of the capacitor 258 is connected to the reference-side vertical signal line VSL2. The switching element 256 can make the reference-side vertical signal line VSL2 conductive or non-conductive. One end of the capacitor 259 is connected to the floating diffusion region 254, and another end is connected to the reference-side vertical signal line VSL2.

A conductive state or a non-conductive state of each of the switching elements 243 and 247 is controlled by control signals RST0 and FDGO of the system control unit 220. Similarly, a conductive state or a non-conductive state of each of the switching elements 253 and 257 is controlled by control signals RST1 and FDG1 of the system control unit 220.

As illustrated in FIG. 18, in the high-gain connection state, the switching elements 243 and 246 are conductive, and the switching element 247 is set to be non-conductive. That is, capacitance of the capacitors 244a and 248 are not connected to the floating diffusion region 244. Similarly, the switching elements 2543 and 256 are conductive, and the switching element 257 is set to be non-conductive. That is, capacitance of the capacitors 254a and 258 are not connected to the floating diffusion region 254.

Conversion efficiency n of the differential amplifier 305 in such a state is represented by Expression (1).

$$\begin{matrix}[ Math . 1 ] & \\ η = \frac{e}{\frac{{C}_{FD 1} + {C}_{FD - VSL 1}}{- Av} + {C}_{FD - VSL 1}} & ( 1 )\end{matrix}$$

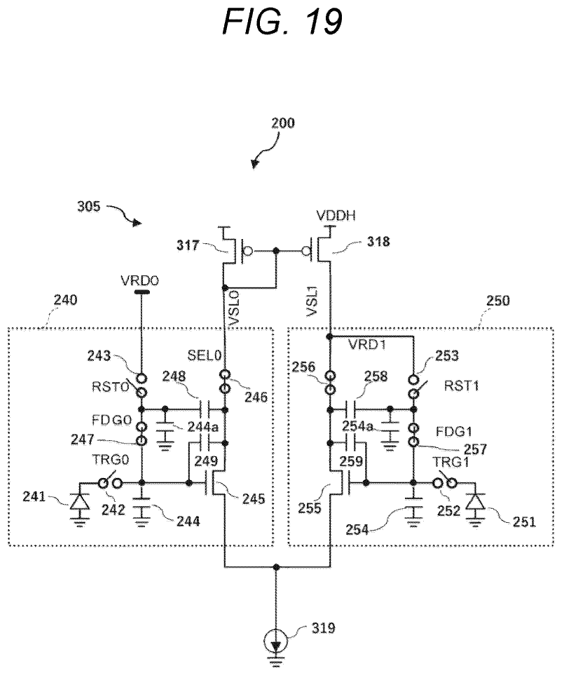

FIG. 19 is a diagram illustrating a low-gain connection state. As illustrated in FIG. 19, in the low-gain connection state, the switching element 243 is non-conductive, and the switching element 247 is set to be conductive. That is, the capacitors 244a and 248 are connected to the floating diffusion region 244. As described above, in the low-gain connection state, the capacitor 244a is connected in parallel to the floating diffusion region 244, one ends of the capacitors 248 and 249 connected in parallel are connected to the floating diffusion region 244, and other ends are connected to the signal-side vertical signal line VSL1.

Similarly, in the low-gain connection state, the switching element 253 is non-conductive, and the switching element 257 is set to be conductive. That is, the capacitors 254a and 258 are connected to the floating diffusion region 244. As described above, in the low-gain connection state, the capacitor 254a is connected in parallel to the floating diffusion region 254, one ends of the capacitors 258 and 2549 connected in parallel are connected to the floating diffusion region 244, and other ends are connected to the reference-side vertical signal line VSL2.

Conversion efficiency n of the differential amplifier 305 in such a state is represented by Expression (2).

$$\begin{matrix}[ Math . 2 ] & \\ η = \frac{e}{\frac{{C}_{FD 1} + {C}_{FD - VSL 1} + {C}_{FD 2} + {C}_{FD - VSL 2}}{- Av} + {C}_{FD - VSL 1} + {C}_{FD - VSL 2}} & ( 2 )\end{matrix}$$

As described above, according to the present embodiment, capacitance for transferring accumulated charges of the PD 241 and the PD 251 is configured to be switchable. As a result, the conversion efficiency n of the differential amplifier 305 can be switched in two stages.

### Seventh Embodiment

A photodetection element 200 according to a seventh embodiment is different from the photodetection element 200 according to the first embodiment in that connection of an amplification transistor of a pixel PXn can be switched to the reference-side signal line VSL0 or the signal-side signal line VSL1. Differences from the photodetection element 200 according to the first embodiment will be described hereinafter.

### [Configuration Example of Pixel Circuit]

The photodetection element 200 according to the seventh embodiment also has the third mode in which addition and subtraction are performed. Note that, in the photodetection element 200 according to the present embodiment, too, the switches 311 to 316, the determiner 320, and the like can be configured, for example, as in the readout circuit 310 (see FIG. 5 and the like) according to the first embodiment. That is, although the third mode will be described in the following description, the first mode and the second mode can also be executed.

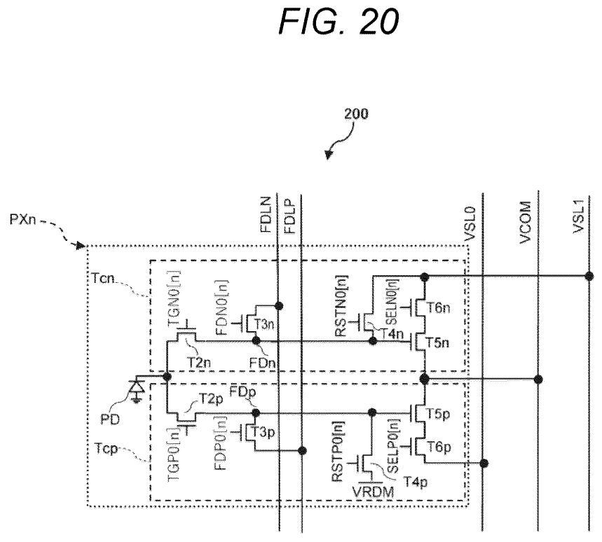

FIG. 20 is a diagram illustrating a configuration example of the pixel PXn according to the seventh embodiment. As illustrated in FIG. 20, the pixel PXn includes a photodiode PD, a negative-side transistor circuit Tcn, and a positive-side transistor circuit Tcp. The negative-side transistor circuit Tcn and the positive-side transistor circuit Tcp have the same configuration. That is, the negative-side transistor circuit Tcn includes a transfer transistor T2n, a connection transistor T3n, a reset transistor T4n, a floating diffusion region FDn, an amplification transistor T5n, and a selection transistor T6n. Similarly, the positive-side transistor circuit Tcp includes a transfer transistor T2p, a connection transistor T3p, a reset transistor T4p, a floating diffusion region FDp, an amplification transistor T5p, and a selection transistor T6p. For example, the transfer transistor T2n, the reset transistor T4n, the floating diffusion region FDn, the amplification transistor T5n, and the selection transistor T6n correspond to the transfer transistor 242, the reset transistor 243, the floating diffusion region 244, the amplification transistor 245, and the selection transistor 246 (see FIG. 6) according to the first embodiment, respectively.

The negative-side connection transistor T3n has one end connected to the floating diffusion region FDn and another end connected to the connection line FDLN. Furthermore, one end of the negative-side reset transistor T4n is connected to the floating diffusion region FDn, and another end is connected to the signal-side signal line VSL1. Furthermore, one end of the negative-side selection transistor T6n is connected to one end of the amplification transistor T5n, and another end is connected to the signal-side signal line VSL1.

The negative-side reset transistor T4n turns on/off discharge of charge accumulated in the floating diffusion region FDn in accordance with a drive signal RSTN0[n] supplied from the vertical drive unit 210. The transfer transistor T2n turns on/off transfer of charge from the photodiode PD to the floating diffusion region FDn in accordance with a drive signal TRGN0[n] supplied from the vertical drive unit 210.

The amplification transistor T5n functions as an amplifier that uses, as input signals, potential fluctuations of the floating diffusion region FDn connected to a gate thereof, and outputs output voltage signals thereof to the vertical signal line VSL1 via the selection transistor T6n. The selection transistor T6n enables or disables the output of the voltage signal from the amplification transistor T5n to the vertical signal line VSL1 in accordance with a drive signal SELN0[n] supplied from the vertical drive unit 210.

Similarly, the positive-side connection transistor T3p has one end connected to the floating diffusion region FDp and another end connected to the connection line FDLP. Furthermore, one end of the positive-side reset transistor T4p is connected to the floating diffusion region FDp, and another end is connected to the power supply of a constant voltage VRDM. Furthermore, one end of the positive-side selection transistor T6p is connected to one end of the amplification transistor T5p, and another end is connected to the reference-side signal line VSL0.

The positive-side reset transistor T4p turns on/off discharge of charge accumulated in the floating diffusion region FDp in accordance with a drive signal RSTP0[n] supplied from the vertical drive unit 210. The transfer transistor T2p turns on/off transfer of charge from the photodiode PD to the floating diffusion region FDp in accordance with a drive signal TRGP0[n] supplied from the vertical drive unit 210.

The amplification transistor T5p functions as an amplifier that uses, as input signals, potential fluctuations of the floating diffusion region FDp connected to a gate thereof, and outputs output voltage signals thereof to the vertical signal line VSL1 via the selection transistor T6p. The selection transistor T6p enables or disables the output of the voltage signal from the amplification transistor T5 to the reference-side signal line VSL0 in accordance with a drive signal SELP0[n] supplied from the vertical drive unit 210.

### [Configuration Example of Addition Pixel Circuit]

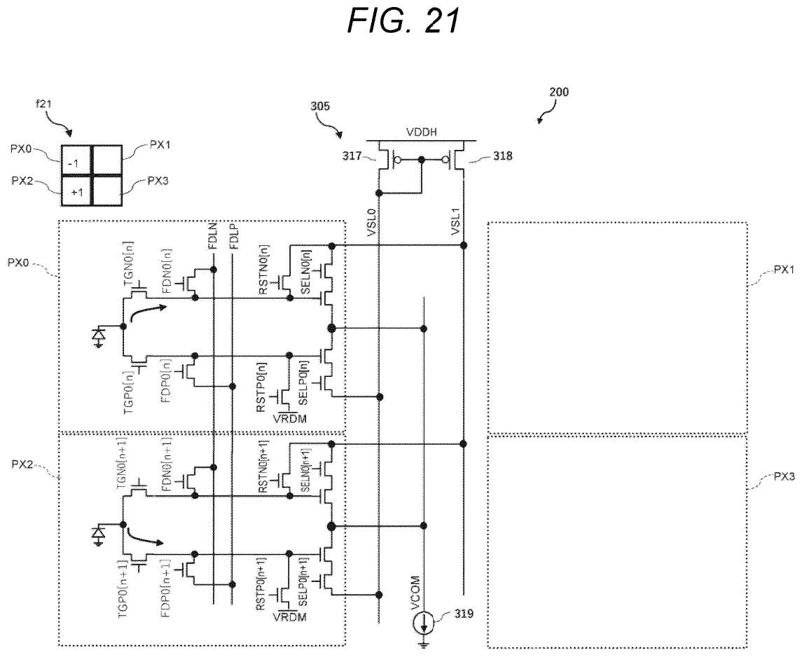

FIGS. 21, 23, 25, 27, and 29 are diagrams illustrating connection examples of a plurality of pixels PXn connected to the vertical signal lines VSL0 and VSL1. As described in these drawings, the plurality of pixels PXn connected to the vertical signal lines VSL0 and VSL1 can perform addition and subtraction. Note that, in the following description with reference to the drawings, reference numerals of elements in the pixels PXn might be omitted in order to simplify the drawings.

FIG. 21 is a diagram illustrating an example of addition and subtraction between two pixels arranged in the same column. FIG. f21 is a diagram illustrating an addition state in four adjacent pixels. As illustrated in FIG. f21, processing for subtracting a luminance signal of a pixel PX0 from a luminance signal of a pixel PX2 in the same column is performed.

As illustrated in FIG. 21, the gate signal SELN0[n] of the negative-side selection transistor T6n of the pixel PX0 is at the high level, a gate signal SELP0[n+1] of the positive-side selection transistor T6p of the pixel PX2 is at the high level, and the gate signals of the other selection transistors T6 are at the low level. As a result, a differential amplifier 305 in which the negative-side amplification transistor T5n of the pixel PX0 and the positive-side amplification transistor T5p of the pixel PX2 are a differential pair is configured. As can be seen from the above, a difference signal between the potential of the floating diffusion region FDn of the pixel PX0 and the potential of the floating diffusion region FDp of the pixel PX2 is amplified by the differential amplifier 305 and converted into a digital signal by the column signal processing unit 260. Note that, in the second mode, edge determination between the pixel PX0 and the pixel PX2 can be performed by the determiner 320 (not illustrated) (see FIG. 5 and the like).

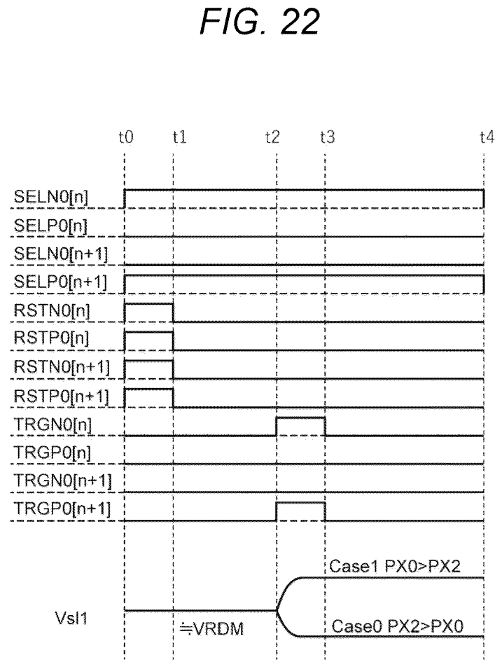

FIG. 22 is a time chart illustrating an operation example of the differential amplifier 305 and the pixels PX0 and PX2 in FIG. 21 in the third mode. Signals SELN0[n], SELP0[n], SELN1[n+1], SELP1[n+1], RSTN0[n], RSTP0[n], RSTN1[n+1], RSTP1[n+1], TRGN0[n], TRGP0[n], TRGN1[n+1], and TRGP1[n+1] and the potential Vsl1 are illustrated from the top. The potential Vsl1 is the voltage of the signal-side vertical signal line VSL1.

First, imaging for a predetermined time is completed, and at a timing t0, the selection control signal SELN0[n] and the selection control signal SELP1[n+1] supplied to the pixel PX2 in the same column as the pixel PX0 for which readout of a pixel signal has been selected are set to the high level (high), and the negative-side selection transistor T6n of the second pixel PX0 and the positive-side selection transistor T6p of the pixel PX2 are turned on. The selection control signal SELN0[n] and the selection control signal SELP1[n+1] are at the high level until a time t4 when the third mode ends, and as a result, a negative side of the pixel PX0 and a positive side of the pixel PX2 are selected, and a differential amplifier 305 in which the negative-side selection transistor T6n of the pixel PX0 and the positive-side selection transistor T6p of the pixel PX2 are a differential pair is configured.

Furthermore, a reset period is started at the timing to, and the reset control signals RSTN0[n], RSTP0[n], RSTN1[n+1], and RSTP1[n+1] are set to the high level (high). As a result, all the reset transistors T4n and T4p of the pixel PX0 and the pixel PX2 are turned on.

In this state, the differential amplifier 305 operates as a voltage follower, the potential of the positive-side floating diffusion region FDp of the pixel PX2 becomes the reset voltage VRDM, and the potential of the negative-side floating diffusion region FDn of the pixel PX0 also follows the reset voltage VRDM. Thereafter, at a next time t1, the reset control signals RSTN0[n], RSTP0[n], RSTN1[n+1], and RSTP1[n+1] are changed to the low level (LOW), and all the reset transistors T4n and T4p are turned off.

During a period from a time t2 to a time t3, the high-level transfer control signal TRGN0[n] is supplied to the negative-side transfer transistor T2n of the pixel PX0 to turn on the transfer transistor T2n and transfer signal charge accumulated in the photodiode PD to the floating diffusion region FDn. Similarly, the high-level transfer control signal TRGP0[n+1] is supplied to the positive-side transfer transistor T2p of the pixel PX2 to turn on the transfer transistor T2p and transfer signal charge accumulated in the photodiode PD to the floating diffusion region FDp.

As a result, a potential difference between the pixel PX0 and the pixel PX2 is amplified by the differential amplifier 305 and starts to fluctuate as the potential Vsl1 of the signal-side vertical signal line VSL1. This fluctuation signal is converted into a digital signal by the column signal processing unit 260 as a subtraction value of the pixel PX0 with respect to the pixel PX2. Furthermore, in a case where the positive side and the negative side of the amplification transistors T5 on a selected side of the pixel PX0 and the pixel PX2 are reversed, the fluctuation signal is converted into a digital signal by the column signal processing unit 260 as a subtraction value of the pixel PX2 with respect to the pixel PX0. The digital signal is then output to the signal processing unit 280, and a difference image is generated.

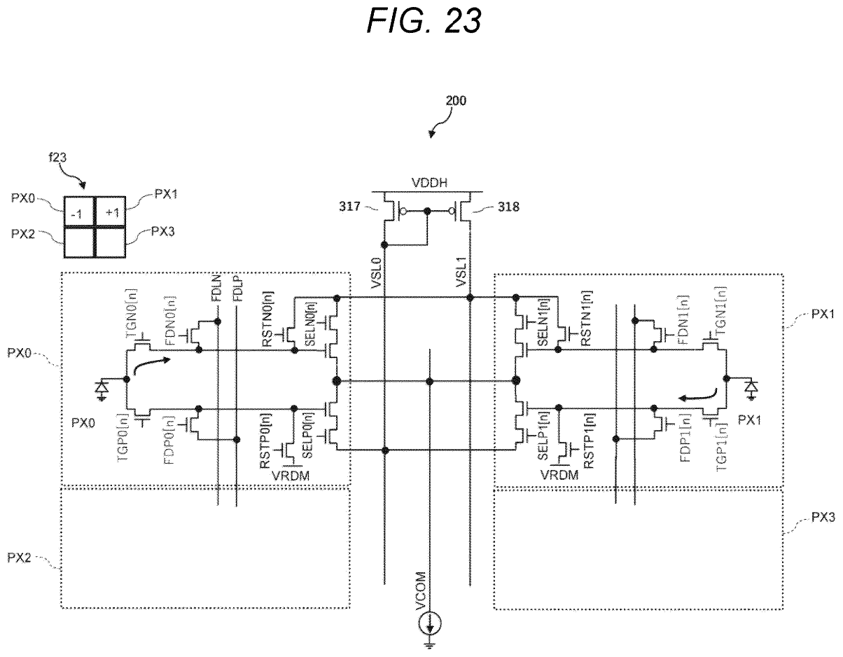

FIG. 23 is a diagram illustrating an example of addition and subtraction between two pixels arranged in the same row. FIG. f23 is a diagram illustrating an addition state in four adjacent pixels. As illustrated in FIG. f23, processing for subtracting a luminance signal of a pixel PX0 from a luminance signal of a pixel PX1 in the same row is performed.

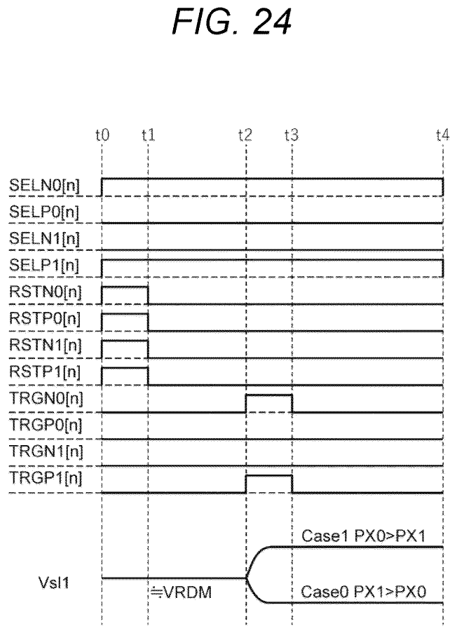

As illustrated in FIG. 24, the gate signal SELN0[n] of the negative-side selection transistor T6n of the pixel PX0 is at the high level, the gate signal SELP1[n] of the positive-side selection transistor T6p of the pixel PX1 is at the high level, and the gate signals of the other selection transistors T6n and T6p are at the low level. As a result, a differential amplifier 305 in which the negative-side amplification transistor T6n of the pixel PX0 and the positive-side amplification transistor T5p of the pixel PX1 are a differential pair is configured.

FIG. 24 is a time chart illustrating an operation example of the differential amplifier 305 and the pixels PX0 and PX1 in FIG. 23 in the third mode. Signals SELN0[n], SELP0[n], SELN1[n], SELP1[n], RSTN0[n], RSTP0[n], RSTN1[n], RSTP1[n], TRGN0[n], TRGP0[n], TRGN1[n], and TRGP1[n] and the potential Vsl1 are illustrated from the top. The potential Vsl1 is the voltage of the signal-side vertical signal line VSL1.

The similar operation as in FIG. 22 is performed, and the fluctuation signal is converted into a digital signal by the column signal processing unit 260 as a subtraction value of the pixel PX0 with respect to the pixel PX1. Similarly to the above, in a case where the positive side and the negative side of the amplification transistors T5 on the selected side of the pixel PX0 and the pixel PX1 are reversed, the fluctuation signal is converted into a digital signal by the column signal processing unit 260 as a subtraction value of the pixel PX1 with respect to the pixel PX0. Addition and subtraction can thus be performed between any two pixels connected to the signal lines VSL0 and VSL1. Similarly, in the second mode, edge determination between any two pixels connected to the signal lines VSL0 and VSL1 can be performed by the determiner 320 (not illustrated) (see FIG. 5 and the like).

In this manner, for example, the potential difference between the potential of the floating diffusion region 244 in the first pixel 240 (PX0) and the potential of the floating diffusion region 254 in the second pixel 250 (PX1) is amplified by the differential amplifier 305 and input to the inverter 323. As a result, when the potential difference between the potential of the floating diffusion region 244 and the potential of the floating diffusion region 254 exceeds a predetermined value, it can be determined that an edge is present. In this case, since the potential difference between the potential of the floating diffusion region 244 and the potential of the floating diffusion region 254 is amplified, an effect on noise is suppressed.

### [Binning Drive]

Here, binning drive with four pixels PX will be described. The binning drive is a drive in which floating diffusion region FDs of selected pixels PX are connected in parallel with each other. Furthermore, each pixel PX according to the present embodiment includes two floating diffusion regions FDn and FDp. Therefore, there are a high conversion mode with a high conversion rate using only one of the two floating diffusion regions FDn and FDp of each pixel PX and a low conversion mode with a low conversion rate using both the two floating diffusion regions FDn and FDp of each pixel PX

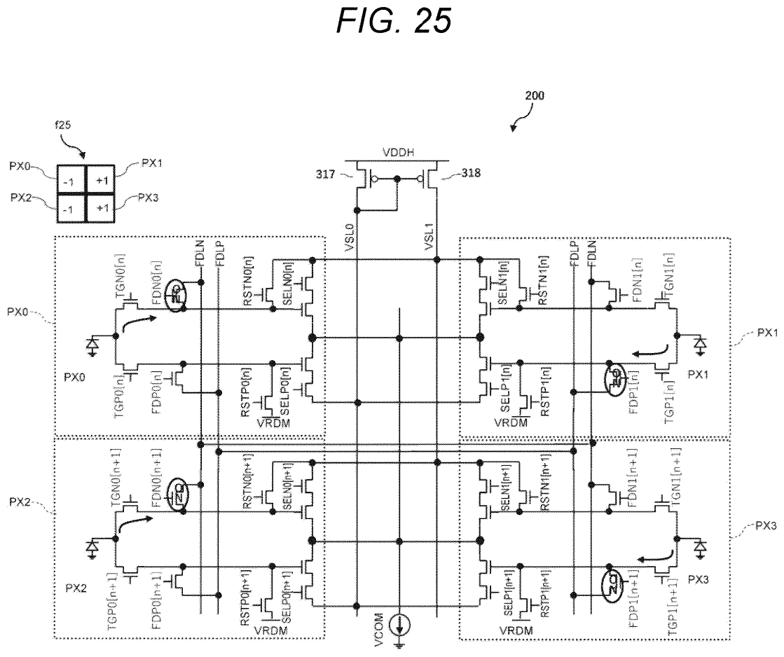

FIG. 25 is a diagram illustrating an operation example of a binning drive example at a high conversion rate. FIG. f25 is a diagram illustrating an addition state in the four adjacent pixels. As illustrated in FIG. f25, processing for subtracting luminance signals of pixels PX1 and PX3 from luminance signals of pixels PX0 and PX2 is performed. Two pixels on an addition side among the four pixels or two pixels on a subtraction side can be connected to the signal lines VSL and VSL1 in any combination. Similarly, in the second mode, edge determination between any two pixels connected to the signal lines VSL0 and VSL1 can be performed by the determiner 320 (not illustrated) (see FIG. 5 and the like). For example, edge determination between the pixel PX0 and the pixel PX2 and between the pixel PX1 and the pixel PX3 is possible.

As illustrated in FIG. 25, gate signals FDN0[n] and FDN0[n+1] of negative-side connection transistors T3n of the pixels PX0 and PX2 are at the high level, gate signals FDP1[n] and FDP1[n+1] of positive-side connection transistors T3p of the pixels PX1 and PX3 are at the high level, and gate signals of other connection transistors T3n and T3p are at the low level.

As a result, the negative-side floating diffusion regions FDn of the pixels PX0 and PX2 are connected in parallel, and the positive-side floating diffusion regions FDp of the pixels PX1 and PX3 are connected in parallel.

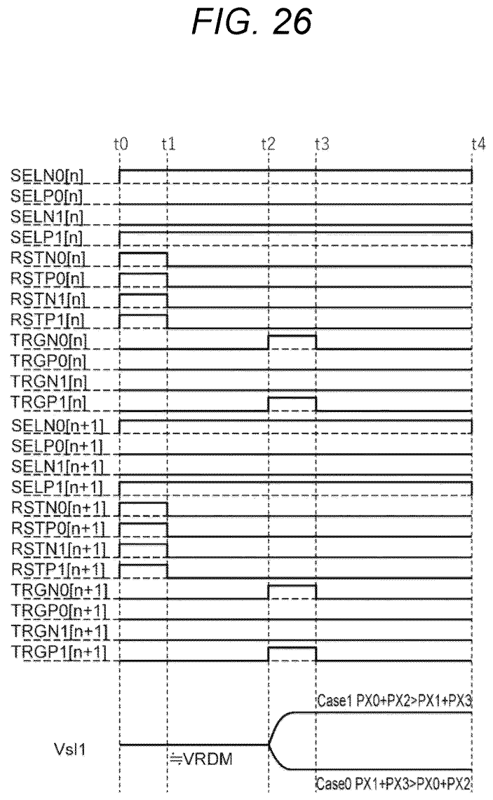

FIG. 26 is a time chart illustrating an operation example of the differential amplifier 305 and the pixels PX0, PX1, PX2, and PX3 in FIG. 25 in the third mode. Signals SELN0[n], SELP0[n], SELN1[n], SELP1[n], RSTN0[n], RSTP0[n], RSTN1[n], RSTP1[n], TRGN0[n], TRGP0[n], TRGN1[n], TRGP1[n], SELN0[n+1], SELP0[n+1], SELN1[n+1], SELP1[n], RSTN0[n], RSTP0[n], RSTN1[n], RSTP1[n], TRGN0[n], TRGP0[n], TRGN1 [n+1], and TRGP1[n+1] and the potential Vsl1 are illustrated from the top. The potential Vsl1 is the voltage of the signal-side vertical signal line VSL1.

First, imaging for a predetermined time is completed, and at a timing to, the selection control signals SELN0[n], SELP1[n], SELN0[n+1], and SELP1[n+1] supplied to the pixels PX0, PX1, PX2 and PX3 for which readout of pixel signals has been selected are set to the high level (high), and the negative-side selection transistor T6n of the pixel PX0, the positive-side selection transistor T6p of the pixel PX1, the negative-side selection transistor T6n of the pixel PX2, and the positive-side selection transistor T6n of the pixel PX3 are turned on. The selection control signals SELN0[n], SELP1[n], SELN0[n+1], and SELP1[n+1] are at the high level until a time t4 when the third mode ends, and as a result, a negative side of the pixels PX0 and PX2 and a positive side of the pixels PX1 and PX3 are selected, and a differential amplifier 305 in which the negative-side selection transistors T6p of the pixels PX0 and PX2 and the positive-side selection transistors T6p of the pixels PX1 and PX3 are differential pairs is configured.

Furthermore, a reset period is started at the timing to, and the reset control signals RSTN0[n], RSTP0[n], RSTN1[n], RSTP1[n], RSTN0[n+1], RSTP0[n+1], RSTN1[n+1], and RSTP1[n+1] are set to the high level (high). As a result, all the reset transistors T4n and T4p of the pixels PX0, PX1, PX2, and PX3 are turned on.

In this state, the differential amplifier 305 operates as a voltage follower, the potentials of the positive-side floating diffusion regions FDp of the pixels PX1 and PX3 become the reset voltage VRDM, and the potentials of the negative-side floating diffusion regions FDn of the pixels PX0 and PX2 also follow the reset voltage VRDM. Thereafter, at a next time t1, the reset control signals RSTN0[n], RSTP0[n], RSTN1[n], RSTP1[n], RSTN0[n+1], RSTP0[n+1], RSTN1[n+1], and RSTP1[n+1] are changed to the low level (LOW), and all the reset transistors T4n and T4p are turned off.

During a period from a time t2 to a time t3, the high-level transfer control signals TRGN0[n] and TRGN0[n+1] are supplied to the negative-side transfer transistors T2n of the pixels PX0 and PX2 to turn on the transfer transistors T2n and transfer signal charge accumulated in the photodiodes PD of the pixels PX0 and PX2 to the floating diffusion regions FDn of the pixels PX0 and PX2 connected in parallel. Similarly, the high-level transfer control signals TRGP1[n] and TRGP1[n+1] are supplied to the positive-side transfer transistors T2p of the pixels PX1 and PX3 to turn on the transfer transistors T2p and transfer signal charge accumulated in the photodiodes PD of the pixels PX1 and PX3 to the floating diffusion regions FDp of the pixels PX1 and PX3 connected in parallel.

As a result, a potential difference between the pixel PX0+the pixel PX2 and the pixel PX1+the pixel PX3 is amplified by the differential amplifier 305 and starts to fluctuate as the potential Vsl1 of the signal-side vertical signal line VSL1. This fluctuation signal is converted into a digital signal at the high conversion rate by the column signal processing unit 260 as a subtraction value of addition signals of the pixels PX0 and PX2 with respect to addition signals of the pixels PX1 and PX3.

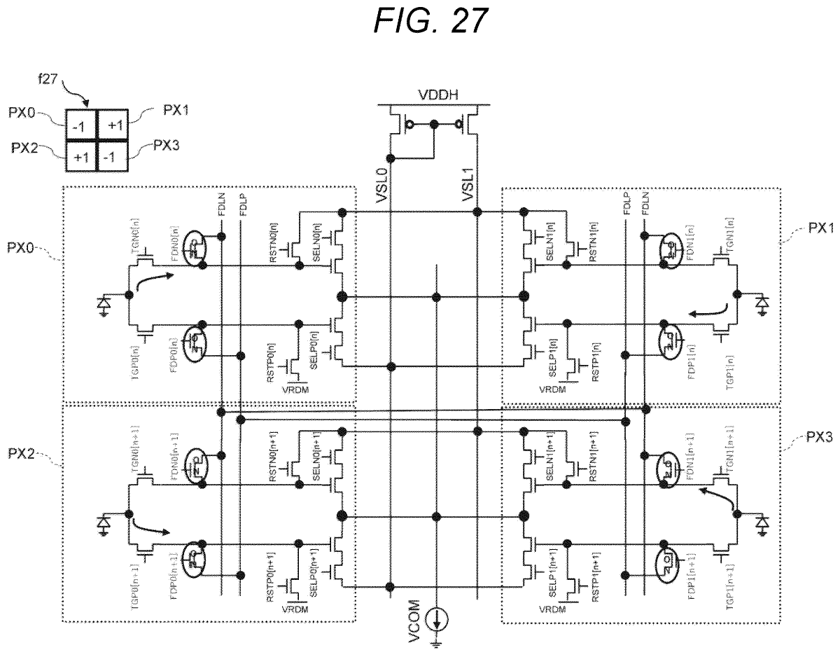

FIG. 27 is a diagram illustrating an operation example of a binning drive example at a low conversion rate. FIG. f27 is a diagram illustrating an addition state in the four adjacent pixels. As illustrated in FIG. f27, processing for subtracting the luminance signals of the pixels PX0 and PX3 from the luminance signals of the pixels PX1 and PX2 is performed. Two pixels on the addition side among the four pixels or two pixels on the subtraction side can be connected to the signal lines VSL and VSL1 in any combination. Similarly, in the second mode, edge determination between any two pixels at the low conversion rate connected to the signal lines VSL0 and VSL1 can be performed by the determiner 320 (not illustrated) (see FIG. 5 and the like). For example, edge determination between the pixel PX0 and the pixel PX3 and between the pixel PX1 and the pixel PX2 is possible.

As illustrated in FIG. 27, the gate signals FDN0[n], FDN1[n], FDN0[n+1], and FDN1[n+1] of the negative-side connection transistors T3n of the pixels PX0, PX1, PX2, and PX3 are at the high level, and the negative-side floating diffusion regions FDn of the pixels PX0, PX1, PX2, and PX3 are connected in parallel. Similarly, the gate signals FDP0[n], FDP1[n], FDP0[n+1], and FDP1[n+1] of the positive-side connection transistors T3p of the pixels PX0, PX1, PX2, and PX3 are at the high level, and the positive-side floating diffusion regions FDp of the pixels PX0, PX1, PX2, and PX3 are connected in parallel.

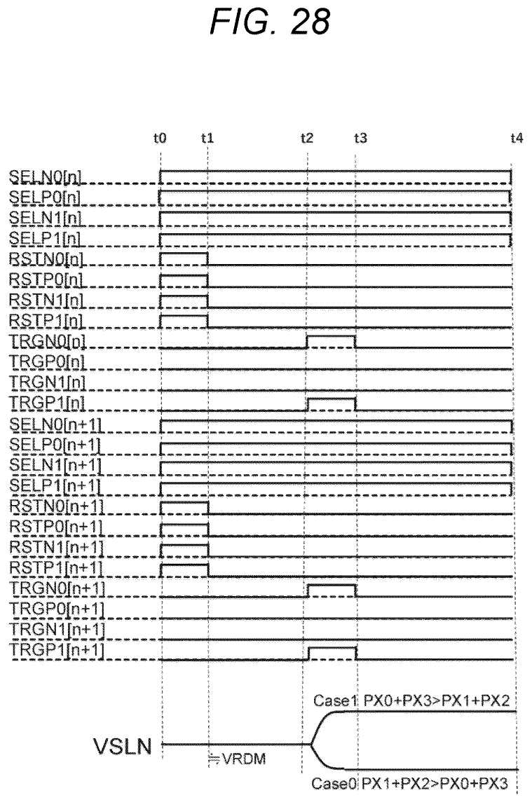

FIG. 28 is a time chart illustrating an operation example of the differential amplifier 305 and the pixels PX0, PX1, PX2, and PX3 in FIG. 27 in the third mode. The signals SELN0[n], SELP0[n], SELN1[n], SELP1[n], RSTN0[n], RSTP0[n], RSTN1[n], RSTP1[n], TRGN0[n], TRGP0[n], TRGN1[n], TRGP1[n], SELN0[n+1], SELP0[n+1], SELN1[n+1], SELP1[n], RSTN0[n], RSTP0[n], RSTN1[n], RSTP1[n], TRGN0[n], TRGP0[n], TRGN1 [n+1], and TRGP1[n+1] and the potential Vsl1 are illustrated from the top. The potential Vsl1 is the voltage of the signal-side vertical signal line VSL1.

First, imaging for a predetermined time is completed, and at a timing to, the selection control signal SELN0[n], SELP0[n], SELN0[n+1], SELP0[n+1], SELP1[n], SELN1[n], SELP1[n+1], SELN1[n+1] supplied to the pixels PX0, PX1, PX2, and PX3 for which readout of pixel signals has been selected are set to the high level (high), and all the selection transistors T6n and T6p of the pixels PX0, PX1, PX2, and PX3 are turned on. As a result, the negative side of the pixels PX0, PX1, PX2, and PX3 and the positive side of the pixels PX0, PX1, PX2, and PX3 are selected, and a differential amplifier 305 in which the negative-side selection transistors T6n of the pixels PX0, PX1, PX2, and PX3 and the positive-side selection transistors T6p of the pixels PX0, PX1, PX2, and PX3 are a differential pair is configured.

Furthermore, a reset period is started at the timing to, and the reset control signals RSTN0[n], RSTP0[n], RSTN1[n], RSTP1[n], RSTN0[n+1], RSTP0[n+1], RSTN1[n+1], and RSTP1[n+1] are set to the high level (high). As a result, all the reset transistors T4n and T4p of the pixels PX0, PX1, PX2, and PX3 are turned on.

In this state, the differential amplifier 305 operates as a voltage follower, the potentials of the positive-side floating diffusion regions FDp of the pixels PX0, PX1, PX2, and PX3 become the reset voltage VRDM, and the potentials of the negative-side floating diffusion regions FDn of the pixels PX0, PX1, PX2, and PX3 also follow the reset voltage VRDM. Thereafter, at a next time t1, the reset control signals RSTN0[n], RSTP0[n], RSTN1[n], RSTP1[n], RSTN0[n+1], RSTP0[n+1], RSTN1[n+1], and RSTP1[n+1] are changed to the low level (LOW), and all the reset transistors T4n and T4p are turned off.

During a period from a time t2 to a time t3, the high-level transfer control signals TRGN0[n] and TRGN1[n+1] are supplied to the negative-side transfer transistors T2n of the pixels PX0 and PX3 to turn on the transfer transistors T2n and transfer signal charge accumulated in the photodiodes PD of the pixels PX0 and PX3 to the floating diffusion regions FDn of the pixels PX0, PX1, PX2, and PX3 connected in parallel. Similarly, the high-level transfer control signals TRGP1[n] and TRGP0[n+1] are supplied to the positive-side transfer transistors T2p of the pixels PX1 and PX2 to turn on the transfer transistors T2p and transfer signal charge accumulated in the photodiodes PD of the pixels PX1 and PX2 to the floating diffusion regions FDp of the pixels PX0, PX1, PX2, and PX3 connected in parallel.

As a result, a potential difference between the pixel PX0+the pixel PX3 and the pixel PX1+the pixel PX2 is amplified by the differential amplifier 305 and starts to fluctuate as the potential Vsl1 of the signal-side vertical signal line VSL1. This fluctuation signal is converted into a digital signal at the low conversion rate by the column signal processing unit 260 as a subtraction value of addition signals of the pixels PX0 and PX3 with respect to addition signals of the pixels PX1 and PX2.

### First Modification of Seventh Embodiment

A photodetection element 200 according to a first modification of the seventh embodiment is different from the photodetection element 200 according to the seventh embodiment in that floating diffusion regions FDn and FDp are shared by two adjacent pixels PX. Differences from the photodetection element 200 according to the seventh embodiment will be described hereinafter.

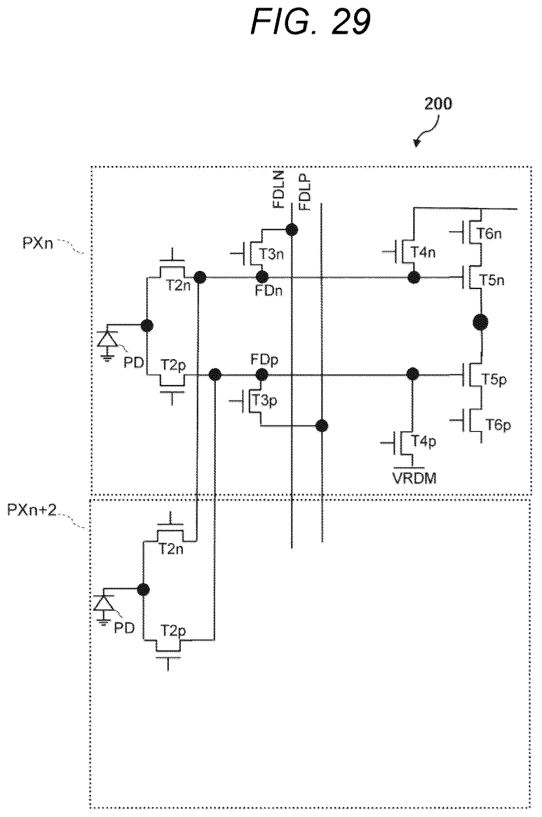

FIG. 29 is a diagram illustrating a configuration example of two adjacent pixels PXn according to the first modification of the seventh embodiment. As illustrated in FIG. 29, the pixel PXn has the same configuration as the pixel PXn (see FIG. 20) according to the seventh embodiment. An adjacent pixel PXn+2 is different from the pixel PXn according to the seventh embodiment in sharing the floating diffusion regions FDn and FDp. As a result, configuration of the pixel PXn+2, the connection transistors T3n and T3p, the reset transistors T4n and T4p, the floating diffusion regions FDn and FDp, the amplification transistors T5n and T5p, and the selection transistors T6n and T6p can be omitted. As a result, the photodetection element 200 can be downsized.

### Second Modification of Seventh Embodiment

A photodetection element 200b according to a second modification of the seventh embodiment is different from the photodetection element 200 according to the seventh embodiment in that connection switches are configured on shared lines FDLN and FDP of the floating diffusion regions FDn and FDp of the pixels PX. Differences from the photodetection element 200 according to the seventh embodiment will be described hereinafter.

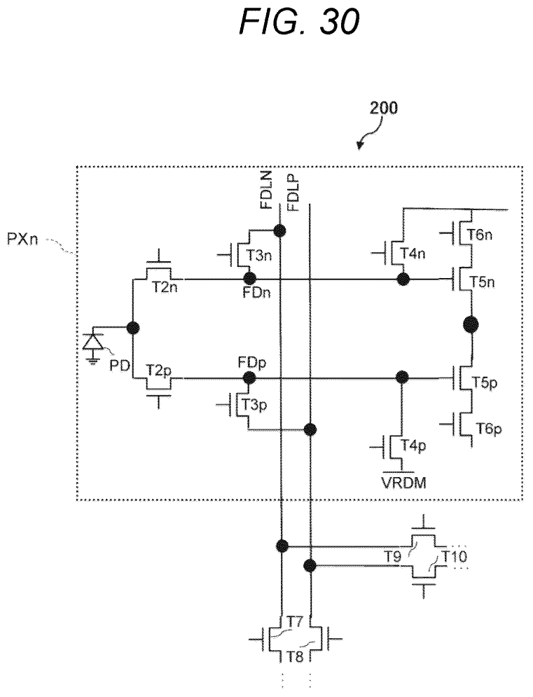

FIG. 30 is a diagram illustrating a configuration example of a pixel PXn according to the second modification of the seventh embodiment. As illustrated in FIG. 30, the pixel PXn has the same configuration as the pixel PXn (see FIG. 25) according to the seventh embodiment. The pixel PXn, on the other hand, is different from the pixel PXn according to the seventh embodiment in further including connection switches T7, T8, T9, and T10 on the shared lines FDLN and FDP. By changing a connected state and a disconnected state of the connection switches T7, T8, T9, and T10, it is possible to control a range in which the binning drive of the pixel PXn is performed. That is, a unit of performing the binning drive can be made variable.

### Third Modification of Seventh Embodiment

The photodetection element 200b according to a third modification of the seventh embodiment is different from the photodetection element 200 according to the seventh embodiment in that configuration of a connection transistor, a reset transistor, a floating diffusion region, an amplification transistor, and a selection transistor are shared by two pixels PX that separately contact with each other in each row. Differences from the photodetection element 200 according to the seventh embodiment will be described hereinafter.

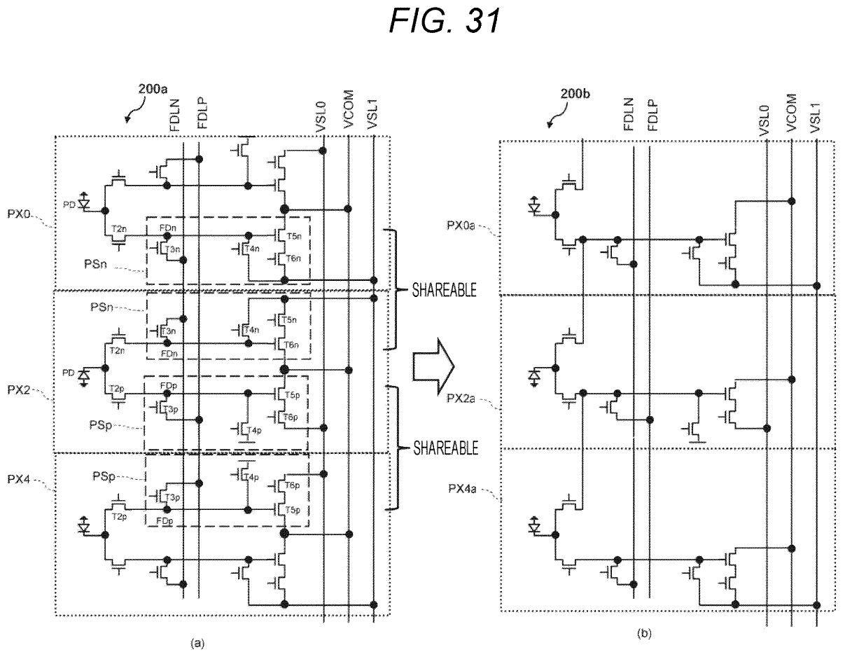

FIG. 31 is a diagram illustrating a configuration example of a pixel PXn according to the third modification of the seventh embodiment. As illustrated in FIG. 31(a), pixels PX0 and PX2 have the same configuration as the pixels PX0 and PX2 (see FIG. 25) according to the seventh embodiment, and the pixels PX0 and PX2 are arranged as line targets. Negative-side transistor circuits PSn of the pixels PX0 and PX2 can be shared. Similarly, positive-side transistor circuits PSp of the pixels PX2 and PX3 can be shared.

In FIG. 31(b), the photodetection element 200b according to the third modification of the seventh embodiment is configured by sharing the negative-side transistor circuits PSn of the pixels PX0 and PX2 and sharing the positive-side transistor circuits PSp of the pixels PX2 and PX3. As a result, the circuit can be downsized while maintaining the same function as the photodetection element 200 according to the seventh embodiment.

### Fourth Modification of Seventh Embodiment

A photodetection element 200d according to a fourth modification of the seventh embodiment is different from the photodetection element 200 according to the seventh embodiment in that configuration of a connection transistor, a reset transistor, a floating diffusion region, an amplification transistor, and a selection transistor are shared by two pixels PX that separately contact with each other in each column. Differences from the photodetection element 200 according to the seventh embodiment will be described hereinafter.

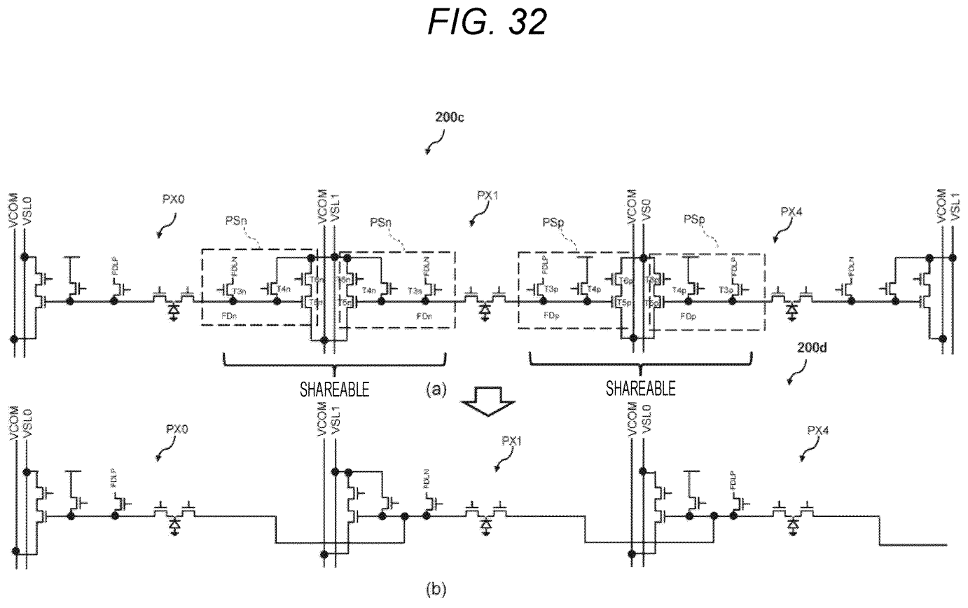

FIG. 32 is a diagram illustrating a configuration example of a pixel PXn according to the fourth modification of the seventh embodiment. As illustrated in FIG. 32(a), pixels PX0 and PX1 have the same configuration as the pixels PX0 and PX1 (see FIG. 25) according to the seventh embodiment, and the pixels PX0 and PX1 are arranged to have symmetry for each column. Negative-side transistor circuits PSn of the pixels PX0 and PX1 can be shared. Similarly, positive-side transistor circuits PSp of the pixels PX3 and PX5 can be shared.

In FIG. 32(b), the photodetection element 200d according to the fourth modification of the seventh embodiment is configured by sharing the negative-side transistor circuits PSn of the pixels PX0 and PX1 and sharing the positive-side transistor circuits PSp of the pixels PX1 and PX3. As a result, the circuit can be downsized while maintaining the same function as the photodetection element 200 according to the seventh embodiment.

### Fifth Modification of Seventh Embodiment

A photodetection element 200e according to a fifth modification of the seventh embodiment is different from the photodetection element 200 according to the seventh embodiment in that configuration of a connection transistor, a reset transistor, a floating diffusion region, an amplification transistor, and a selection transistor are shared by four adjacent pixels. Differences from the photodetection element 200 according to the seventh embodiment will be described hereinafter.

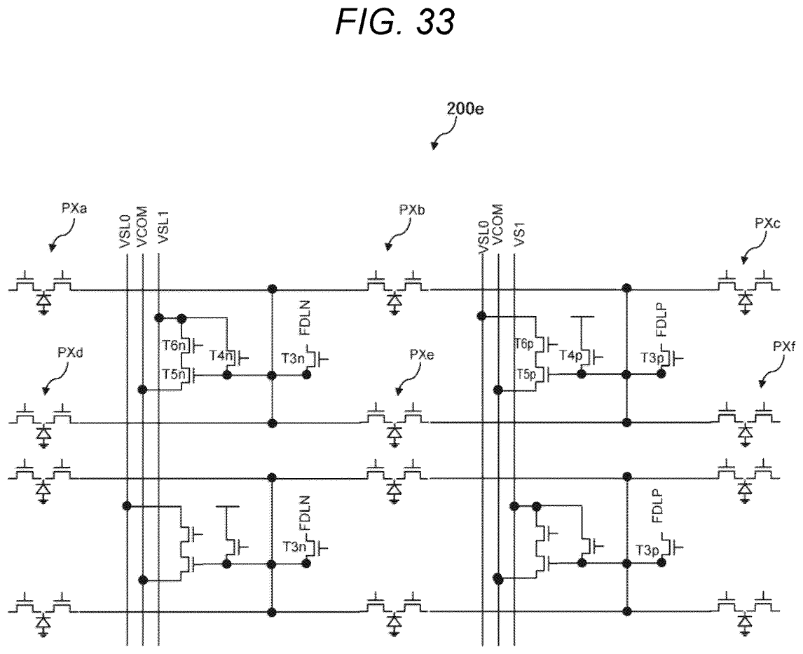

FIG. 33 is a diagram illustrating a configuration example of the photodetection element 200e according to the fifth modification of the seventh embodiment. As illustrated in FIG. 33, the pixels PXa, PXb, PXc, and PXd are configured to
share configuration of a connection transistor, a reset transistor, a floating diffusion region, an amplification transistor, and the selection transistor. As a result, the circuit can be further downsized while maintaining the same function as the photodetection element 200 according to the seventh embodiment.

### Sixth Modification of Seventh Embodiment

A photodetection element 200f according to a sixth modification of the seventh embodiment is different from the photodetection element 200 according to the seventh embodiment in that a pixel range to be added is 2×2, 3×3, or 4×4, and accumulation time of each pixel can be changed. Differences from the photodetection element 200 according to the seventh embodiment will be described hereinafter.

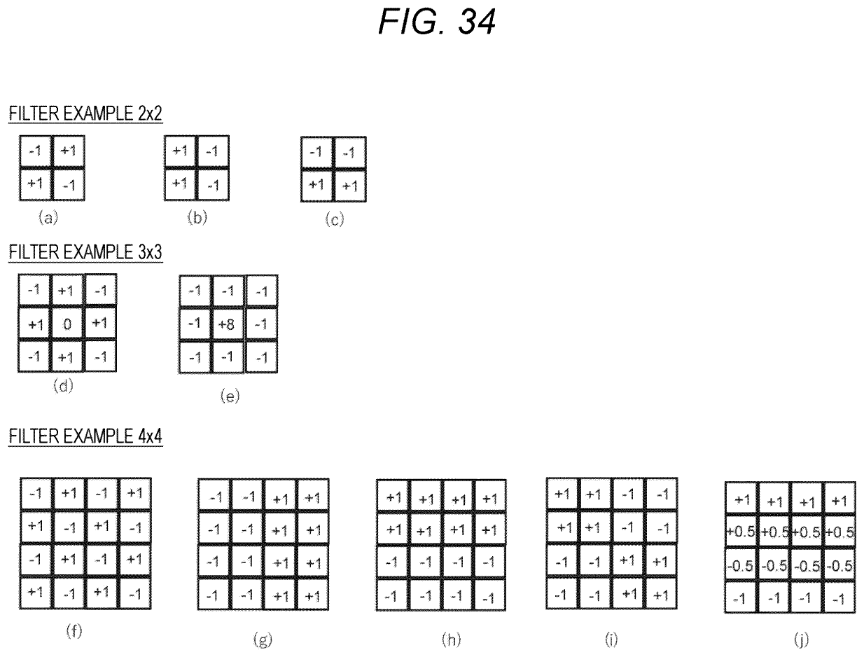

FIG. 34 is a diagram illustrating examples of an addition range and addition coefficients of the photodetection element 200f according to the sixth modification of the seventh embodiment. For example, connection ranges of the connection switches T7, T8, T9, and T10 of the shared lines FDLN and FDP illustrated in FIG. 30 are illustrated. For example, the pixel range is 2×2 in (a), (b), and (c) of the drawing, the pixel range is 3×3 in (d) and (e) of the drawing, and the pixel range is 4×4 in (f), (g), and (h) of the drawing. Furthermore, coefficients of 0.5, 8, and the like are examples in which the accumulation time is 0.5 or 8 times or the like for a pixel having an accumulation time of 1. Note that, as in (d) and (e) of the drawing, in a case where the pixel range is 3×3, three-system horizontal wiring may be employed. Furthermore, there may be a pixel that does not contribute to addition and subtraction.

### OTHER CONFIGURATION EXAMPLES

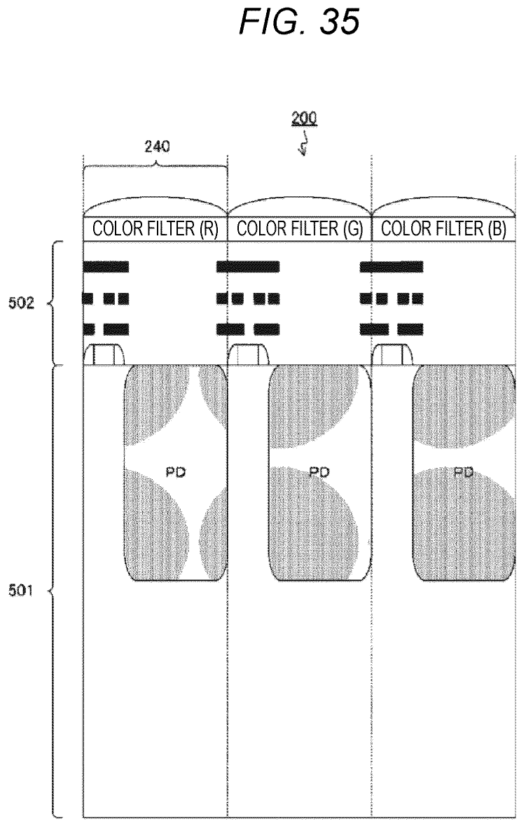

The photodetection element 200 according to the present embodiment can have configurations in FIGS. 35 to 38. FIG. 35 is an example of a cross-sectional view of a front-illuminated CMOS image sensor 200 in the present embodiment. A wiring layer 502 is arranged below a microlens, and a photoelectric conversion layer 501 is provided below the wiring layer 502. Transistors and signal lines are provided in the wiring layer 502. Photodiodes are disposed in the photoelectric conversion layer 501.

As illustrated in the drawing, in the CMOS image sensor 200 in which the wiring layer 502 is arranged between the microlens and the photoelectric conversion layer 501, a front surface that is a surface on which a circuit is arranged is irradiated with light. Such a solid-state imaging device is referred to as a front-illuminated solid-state imaging device.

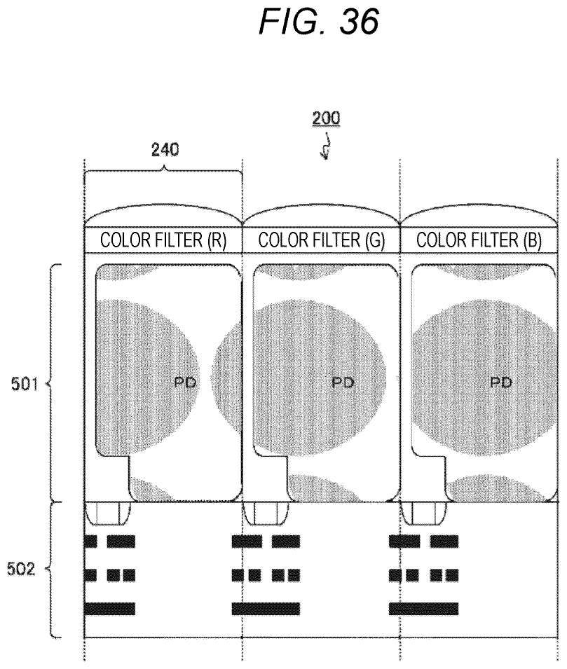

FIG. 36 is an example of a cross-sectional view of a back-illuminated CMOS image sensor 200 in the present embodiment. As illustrated in FIG. 36, a back-illuminated structure can also be used. A photoelectric conversion layer 501 is arranged below a microlens, and a wiring layer 502 is provided below the photoelectric conversion layer 501.

As illustrated in the drawing, in the CMOS image sensor 200 in which the photoelectric conversion layer 501 is arranged between the microlens and the wiring layer 502, a back surface opposed to a front surface is irradiated with light. Such a solid-state imaging device is referred to as a back-illuminated solid-state imaging device. In a back-illuminated type, light is not blocked by a part of the wiring layer, so that sensitivity can be made higher than that of a front-illuminated type.

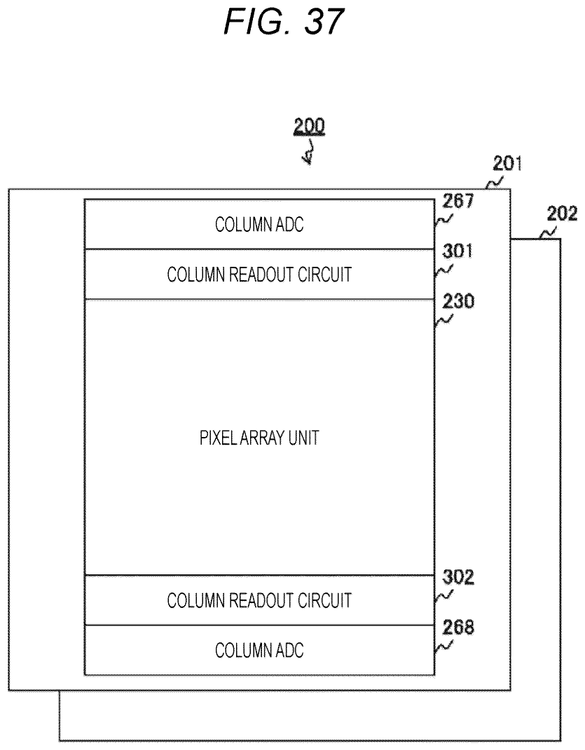

FIG. 37 is a diagram illustrating an example of a back-illuminated multilayer structure. In a case where the back-illuminated structure is used, as illustrated in FIG. 37, a multilayer structure in which a pixel substrate 201 and a support substrate 202 are stacked can be used. On the pixel substrate 201, a pixel array unit 230, column readout circuits 301 and 302, and column ADCs 267 and 268 are arranged. Half of circuits in the column readout circuit unit 300 are arranged in the column readout circuit 301, and the rest are arranged in the column readout circuit 302. Furthermore, half of ADCs in the column signal processing unit 260 are arranged in the column ADC 267, and the rest are arranged in the column ADC 268.

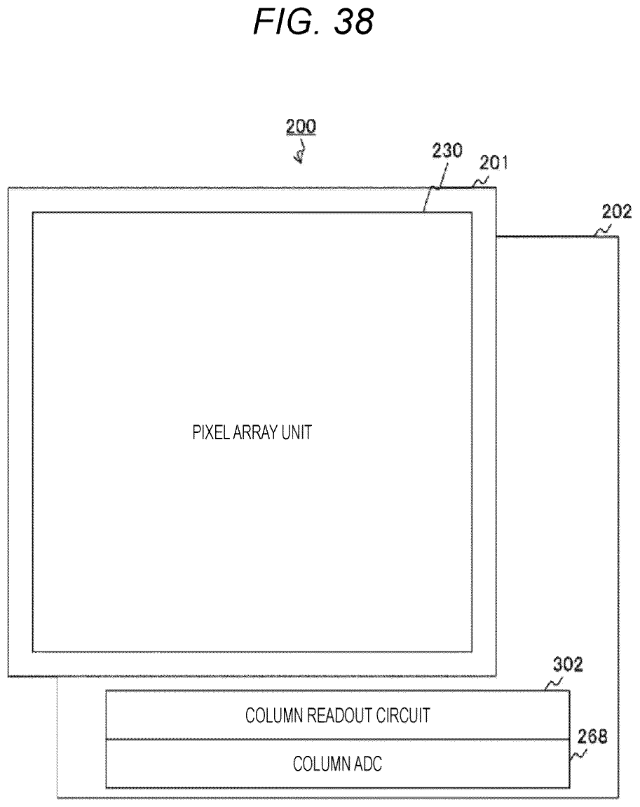

FIG. 38 is a diagram illustrating another example of the multilayer structure. Note that, in a case where a multilayer structure is used, as illustrated in FIG. 38, only the pixel array unit 230 may be arranged on the pixel substrate 201, and a subsequent circuit may be arranged on the support substrate 202.

Note that the present technology may have the following configurations.

(1)

A photodetection element including:
a pixel array unit including a plurality of first pixels connected to a first signal line and including first amplification transistors that amplify potentials corresponding to charges obtained as a result of photoelectric conversion performed by first photoelectric conversion elements and a plurality of second pixels connected to a second signal line different from the first signal line and including second amplification transistors that amplify potentials corresponding to charges obtained as a result of photoelectric conversion performed by second photoelectric conversion elements;
a differential amplification circuit that amplifies a potential difference of a differential pair, which is the first amplification transistor of a first pixel selected from among the plurality of first pixels and the second amplification transistor of a second pixel selected from among the plurality of second pixels; and
a determiner configured to determine, on a basis of the potential difference amplified by the differential amplification circuit, whether or not there is an edge between the selected first pixel and the selected second pixel.
   (2)

The photodetection element according to (1), in which
each of the plurality of first pixels includes
the first photoelectric conversion element,
a first transfer transistor having one end connected to the first photoelectric conversion element,
a first floating diffusion region connected to another end of the first transfer transistor,
a first reset transistor having one end connected to the first floating diffusion region and another end connected to a power supply of a constant potential, and
a first selection transistor having one end connected to the first signal line and another end connected to one end of the first amplification transistor,
each of the plurality of second pixels includes
the second photoelectric conversion element,
a second transfer transistor having one end connected to the second photoelectric conversion element,
a second floating diffusion region connected to another end of the second transfer transistor, and
a second reset transistor having one end connected to the second floating diffusion region and another end connected to the power supply of the constant potential, and
a second selection transistor having one end connected to the second signal line and another end connected to one end of the second amplification transistor,
a gate of the first amplification transistor is connected to the first floating diffusion region, and
a gate of the second amplification transistor is connected to the second floating diffusion region.
   (3)

The photodetection element according to (1) or (2), in which the differential amplification circuit includes
a current mirror current source load connected to a drain of the differential pair via the first signal line and the second signal line, and
a current source connected to another end of the first amplification transistor and another end of the second amplification transistor.
   (4)

The photodetection element according to (3), in which the determiner outputs a signal indicating that there is an edge in a case where the potential difference amplified by the differential amplification circuit exceeds a predetermined threshold.

(5)

The photodetection element according to (4), in which the determiner outputs the signal indicating that there is an edge in a case where the potential difference amplified by the differential amplification circuit exceeds a predetermined positive-side threshold.

(6)

The photodetection element according to (5), in which the determiner outputs the signal indicating that there is an edge in a case where the potential difference amplified by the differential amplification circuit exceeds a predetermined negative-side threshold.

(7)

The photodetection element according to (4), in which the determiner includes a first capacitor having one end connected to the second signal line, and a converter connected to another end of the first capacitor.

(8)

The photodetection element according to (7), in which the converter includes
a first transistor that has one end connected to the power supply of the constant potential, that has a first gate connected to the another end of the first capacitor, and that becomes conductive in a case where a predetermined low potential is applied to the first gate, and
a second transistor that has one end connected to another end of the first transistor, that has another end connected to ground, that has a second gate connected to the another end of the first capacitor, and that becomes conductive in a case where a predetermined high potential is applied.
   (9)

The photodetection element according to (8), further including a third transistor that has one end connected to the another end of the first capacitor, that has another end connected to the ground, and that becomes conductive under control of a control unit.

(10)

The photodetection element according to (4), in which each of the plurality of first pixels further includes a third capacitor connectable to the first photoelectric conversion element, and
each of the plurality of second pixels further includes a fourth capacitor connectable to the second photoelectric conversion element.
   (11)

A photodetection element including:
a pixel array unit including a plurality of pixels including first amplification transistors that are connected to a first signal line and amplify potentials corresponding to charges obtained as a result of photoelectric conversion performed by photoelectric conversion elements, and second amplification transistors that are connected to a second signal line different from the first signal line and amplify potentials corresponding to charges obtained as a result of photoelectric conversion performed by the photoelectric conversion elements;
a differential amplification circuit that amplifies a potential difference of a differential pair, which is the first amplification transistor of a first pixel selected from among the plurality of pixels and the second amplification transistor of a second pixel selected from among the plurality of pixels and different from the first pixel; and
a circuit unit that generates an image signal on a basis of the potential difference amplified by the differential amplification circuit.
   (12)

The photodetection element according to (11), in which
each of the plurality of pixels includes
the photoelectric conversion element,
a first transfer transistor having one end connected to the photoelectric conversion element,
a first floating diffusion region connected to another end of the first transfer transistor,
a first reset transistor having one end connected to the first floating diffusion region and another end connected to a power supply of a constant potential,
a first selection transistor having one end connected to the first signal line and another end connected to one end of the first amplification transistor,
a second transfer transistor having one end connected to the photoelectric conversion element,
a second floating diffusion region connected to another end of the second transfer transistor,
a second reset transistor having one end connected to the second floating diffusion region and another end connected to the power supply of the constant potential, and
a second selection transistor one end connected to the second signal line and another end connected to one end of the second amplification transistor,
a gate of the first amplification transistor is connected to the first floating diffusion region, and
a gate of the second amplification transistor is connected to the second floating diffusion region.
   (13)

The photodetection element according to (12), in which the differential amplification circuit includes
a current mirror current source load connected to a drain of the differential pair via the first signal line and the second signal line, and
a current source connected to another end of the first amplification transistor and another end of the second amplification transistor.
   (14)

The photodetection element according to (13), further including a differential amplification circuit that amplifies a potential difference of a differential pair, which is first amplification transistors of a plurality of first pixels selected from the plurality of pixels and second amplification transistors of a plurality of second pixels different from the plurality of first pixels and selected from the plurality of pixels, in which
an image signal is generated on a basis of the potential difference amplified by the differential amplification circuit.
   (15)

The photodetection element according to (14), in which each of the plurality of pixels further includes
a first connection transistor having one end connected to the first floating diffusion region and another end connected to a first connection line, and
a second connection transistor having one end connected to the second floating diffusion region and another end connected to a second connection line different from the first connection line.
   (16) The photodetection element according to (15), in which the first connection transistors of the plurality of selected first pixels become conductive, and
the second connection transistors of the plurality of selected second pixels become conductive.
   (17) The photodetection element according to (12), in which the pixel array unit further includes a third pixel, and
the third pixel includes
a third photoelectric conversion element,
a third transfer transistor having one end connected to the first floating diffusion region of at least one of the plurality of pixels and another end connected to the third photoelectric conversion element, and
a fourth transfer transistor having one end connected to the second floating diffusion region of at least one of the plurality of pixels and another end connected to the third photoelectric conversion element.
   (18)

The photodetection element according to (15), in which the first connection line is connected to the first connection transistor of a pixel adjacent via a first switching element, and
the second connection line is connected to the second connection transistor of a pixel adjacent via a third switching element.
   (19)

A photodetection element including:
a pixel array unit including a plurality of first pixels connected to a first signal line and including first amplification transistors that amplify potentials corresponding to charges obtained as a result of photoelectric conversion performed by first photoelectric conversion elements and a plurality of second pixels connected to a second signal line different from the first signal line and including second amplification transistors that amplify potentials corresponding to charges obtained as a result of photoelectric conversion performed by second photoelectric conversion elements;
a differential amplification circuit that amplifies a potential difference of a differential pair, which is the first amplification transistor of a first pixel selected from among the plurality of first pixels and the second amplification transistor of a second pixel selected from among the plurality of second pixels; and
a circuit unit that generates an image signal on a basis of the potential difference amplified by the differential amplification circuit.
   (20)

A photodetection element including:
a pixel array unit including a plurality of first pixels connected to a first signal line via first transfer transistors and including first amplification transistors that amplify potentials corresponding to charges obtained as a result of photoelectric conversion performed by first photoelectric conversion elements and second transfer transistors having one ends connected to the first photoelectric conversion elements, and
a plurality of second pixels connected to a second signal line via third transfer transistors and including second amplification transistors that amplify potentials corresponding to charges obtained as a result of photoelectric conversion performed by second photoelectric conversion elements and fourth transfer transistors having one ends connected to the second photoelectric conversion elements,
other ends of the second transfer transistors being connected to the second signal line,
other ends of the fourth transfer transistors being connected to the first signal line;
a differential amplification circuit that amplifies a potential difference of a differential pair, which is the first amplification transistor of a first pixel selected from among the plurality of first pixels and the second amplification transistor of a second pixel selected from among the plurality of second pixels; and
a circuit unit that generates an image signal on a basis of the potential difference amplified by the differential amplification circuit.
   (21)

A photodetection element including:
a pixel array unit including a plurality of first pixels connected to a first signal line directly or via first transfer transistors and including first amplification transistors that amplify potentials corresponding to charges obtained as a result of photoelectric conversion performed by first photoelectric conversion elements and second transfer transistors having one ends connected to the first photoelectric conversion elements,
a plurality of second pixels connected to second photoelectric conversion elements via the first amplification transistors and third transfer transistors,
a plurality of third pixels connected to third photoelectric conversion elements via the first amplification transistors and fourth transfer transistors, and
a plurality of fifth pixels connected to fourth photoelectric conversion elements via the first amplification transistors and fourth transfer transistors.
   (22)

An electronic device including:
the photodetection element according to (1); and
an optical system that condenses incident light on the pixel array unit.

Aspects of the present disclosure are not limited to the above-described individual embodiments, but include various modifications that can be conceived by those skilled in the art, and the effects of the present disclosure are not limited to those described above. That is, various additions, modifications, and partial deletions may be made without departing from the conceptual idea and spirit of the present disclosure derived from the matters defined in the claims and equivalents thereof.

### REFERENCE SIGNS LIST

100 Electronic device
200, 200a, 200b, 200d, 200e, 200f Photodetection element
230 Pixel array unit
245 Amplification transistor
240 Pixel
241 Photodiode
242 Transfer transistor
243 Reset transistor
244 Floating diffusion region
250 Pixel
252 Transfer transistor
253 Reset transistor
254 Floating diffusion region
255 Amplification transistor
305 Differential amplifier
FDn, FDp Floating diffusion region
T2n, T2p Transfer transistor
T3n, T3p Connection transistor
T4n, T4p Reset transistor
T5n, T5p Amplification transistor
T6n, T6p Selection transistor
VSL0, VSL1 Signal line

1. A photodetection element comprising:
a pixel array unit including a plurality of first pixels connected to a first signal line and including first amplification transistors that amplify potentials corresponding to charges obtained as a result of photoelectric conversion performed by first photoelectric conversion elements and a plurality of second pixels connected to a second signal line different from the first signal line and including second amplification transistors that amplify potentials corresponding to charges obtained as a result of photoelectric conversion performed by second photoelectric conversion elements;
a differential amplification circuit that amplifies a potential difference of a differential pair, which is the first amplification transistor of a first pixel selected from among the plurality of first pixels and the second amplification transistor of a second pixel selected from among the plurality of second pixels; and
a determiner configured to determine, on a basis of the potential difference amplified by the differential amplification circuit, whether or not there is an edge between the selected first pixel and the selected second pixel.

2. The photodetection element according to claim 1, wherein
each of the plurality of first pixels includes
the first photoelectric conversion element,
a first transfer transistor having one end connected to the first photoelectric conversion element,
a first floating diffusion region connected to another end of the first transfer transistor,
a first reset transistor having one end connected to the first floating diffusion region and another end connected to a power supply of a constant potential, and
a first selection transistor having one end connected to the first signal line and another end connected to one end of the first amplification transistor,
each of the plurality of second pixels includes
the second photoelectric conversion element,
a second transfer transistor having one end connected to the second photoelectric conversion element,
a second floating diffusion region connected to another end of the second transfer transistor, and
a second reset transistor having one end connected to the second floating diffusion region and another end connected to the power supply of the constant potential, and
a second selection transistor having one end connected to the second signal line and another end connected to one end of the second amplification transistor,
a gate of the first amplification transistor is connected to the first floating diffusion region, and
a gate of the second amplification transistor is connected to the second floating diffusion region.

3. The photodetection element according to claim 1, wherein the differential amplification circuit includes
a current mirror current source load connected to a drain of the differential pair via the first signal line and the second signal line, and
a current source connected to another end of the first amplification transistor and another end of the second amplification transistor.

4. The photodetection element according to claim 3, wherein the determiner outputs a signal indicating that there is an edge in a case where the potential difference amplified by the differential amplification circuit exceeds a predetermined threshold.

5. The photodetection element according to claim 4, wherein the determiner outputs the signal indicating that there is an edge in a case where the potential difference amplified by the differential amplification circuit exceeds a predetermined positive-side threshold.

6. The photodetection element according to claim 5, wherein the determiner outputs the signal indicating that there is an edge in a case where the potential difference amplified by the differential amplification circuit exceeds a predetermined negative-side threshold.

7. The photodetection element according to claim 4, wherein the determiner includes a first capacitor having one end connected to the second signal line, and
a converter connected to another end of the first capacitor.

8. The photodetection element according to claim 7, wherein the converter includes
a first transistor that has one end connected to the power supply of the constant potential, that has a first gate connected to the another end of the first capacitor, and that becomes conductive in a case where a predetermined low potential is applied to the first gate, and
a second transistor that has one end connected to another end of the first transistor, that has another end connected to ground, that has a second gate connected to the another end of the first capacitor, and that becomes conductive in a case where a predetermined high potential is applied.

9. The photodetection element according to claim 8, further comprising a third transistor that has one end connected to the another end of the first capacitor, that has another end connected to the ground, and that becomes conductive under control of a control unit.

10. The photodetection element according to claim 4, wherein each of the plurality of first pixels further includes a third capacitor connectable to the first photoelectric conversion element, and
each of the plurality of second pixels further includes a fourth capacitor connectable to the second photoelectric conversion element.

11. A photodetection element comprising:
a pixel array unit including a plurality of pixels including first amplification transistors that are connected to a first signal line and amplify potentials corresponding to charges obtained as a result of photoelectric conversion performed by photoelectric conversion elements, and second amplification transistors that are connected to a second signal line different from the first signal line and amplify potentials corresponding to charges obtained as a result of photoelectric conversion performed by the photoelectric conversion elements;
a differential amplification circuit that amplifies a potential difference of a differential pair, which is the first amplification transistor of a first pixel selected from among the plurality of pixels and the second amplification transistor of a second pixel selected from among the plurality of pixels; and
a circuit unit that generates an image signal on a basis of the potential difference amplified by the differential amplification circuit.

12. The photodetection element according to claim 11, wherein
each of the plurality of pixels includes
the photoelectric conversion element,
a first transfer transistor having one end connected to the photoelectric conversion element,
a first floating diffusion region connected to another end of the first transfer transistor,
a first reset transistor having one end connected to the first floating diffusion region and another end connected to a power supply of a constant potential,
a first selection transistor having one end connected to the first signal line and another end connected to one end of the first amplification transistor,
a second transfer transistor having one end connected to the photoelectric conversion element,
a second floating diffusion region connected to another end of the second transfer transistor,
a second reset transistor having one end connected to the second floating diffusion region and another end connected to the power supply of the constant potential, and
a second selection transistor one end connected to the second signal line and another end connected to one end of the second amplification transistor,
a gate of the first amplification transistor is connected to the first floating diffusion region, and
a gate of the second amplification transistor is connected to the second floating diffusion region.

13. The photodetection element according to claim 12, wherein the differential amplification circuit includes
a current mirror current source load connected to a drain of the differential pair via the first signal line and the second signal line, and
a current source connected to another end of the first amplification transistor and another end of the second amplification transistor.

14. The photodetection element according to claim 13, further comprising a differential amplification circuit that amplifies a potential difference of a differential pair, which is first amplification transistors of a plurality of first pixels selected from the plurality of pixels and second amplification transistors of a plurality of second pixels different from the plurality of first pixels and selected from the plurality of pixels, wherein
an image signal is generated on a basis of the potential difference amplified by the differential amplification circuit.

15. The photodetection element according to claim 14, wherein each of the plurality of pixels further includes
a first connection transistor having one end connected to the first floating diffusion region and another end connected to a first connection line, and
a second connection transistor having one end connected to the second floating diffusion region and another end connected to a second connection line different from the first connection line.

16. The photodetection element according to claim 15, wherein the first connection transistors of the plurality of selected first pixels become conductive, and
the second connection transistors of the plurality of selected second pixels become conductive.

17. The photodetection element according to claim 12, wherein the pixel array unit further includes a third pixel, and
the third pixel includes
a third photoelectric conversion element,
a third transfer transistor having one end connected to the first floating diffusion region of at least one of the plurality of pixels and another end connected to the third photoelectric conversion element, and
a fourth transfer transistor having one end connected to the second floating diffusion region of at least one of the plurality of pixels and another end connected to the third photoelectric conversion element.

18. The photodetection element according to claim 15, wherein the first connection line is connected to the first connection transistor of a pixel adjacent via a first switching element, and
the second connection line is connected to the second connection transistor of a pixel adjacent via a third switching element.

19. A photodetection element comprising:
a pixel array unit including a plurality of first pixels connected to a first signal line and including first amplification transistors that amplify potentials corresponding to charges obtained as a result of photoelectric conversion performed by first photoelectric conversion elements and a plurality of second pixels connected to a second signal line different from the first signal line and including second amplification transistors that amplify potentials corresponding to charges obtained as a result of photoelectric conversion performed by second photoelectric conversion elements;
a differential amplification circuit that amplifies a potential difference of a differential pair, which is the first amplification transistor of a first pixel selected from among the plurality of first pixels and the second amplification transistor of a second pixel selected from among the plurality of second pixels; and
a circuit unit that generates an image signal on a basis of the potential difference amplified by the differential amplification circuit.

20. A photodetection element comprising:
a pixel array unit including a plurality of first pixels connected to a first signal line via first transfer transistors and including first amplification transistors that amplify potentials corresponding to charges obtained as a result of photoelectric conversion performed by first photoelectric conversion elements and second transfer transistors having one ends connected to the first photoelectric conversion elements, and
a plurality of second pixels connected to a second signal line via third transfer transistors and including second amplification transistors that amplify potentials corresponding to charges obtained as a result of photoelectric conversion performed by second photoelectric conversion elements and fourth transfer transistors having one ends connected to the second photoelectric conversion elements,
other ends of the second transfer transistors being connected to the second signal line,
other ends of the fourth transfer transistors being connected to the first signal line;
a differential amplification circuit that amplifies a potential difference of a differential pair, which is the first amplification transistor of a first pixel selected from among the plurality of first pixels and the second amplification transistor of a second pixel selected from among the plurality of second pixels; and
a circuit unit that generates an image signal on a basis of the potential difference amplified by the differential amplification circuit.

21. A photodetection element comprising:
a pixel array unit including a plurality of first pixels connected to a first signal line directly or via first transfer transistors and including first amplification transistors that amplify potentials corresponding to charges obtained as a result of photoelectric conversion performed by first photoelectric conversion elements and second transfer transistors having one ends connected to the first photoelectric conversion elements,
a plurality of second pixels connected to second photoelectric conversion elements via the first amplification transistors and third transfer transistors,
a plurality of third pixels connected to third photoelectric conversion elements via the first amplification transistors and fourth transfer transistors, and
a plurality of fifth pixels connected to fourth photoelectric conversion elements via the first amplification transistors and fourth transfer transistors.

22. An electronic device comprising:
the photodetection element according to claim 1; and
an optical system that condenses incident light on the pixel array unit.
